(19) United States
(12) Patent Application Publication
(10) Pub. No.: US 2010/0218093 A1
(43) Pub. Date: Aug. 26, 2010

(54) Control apparatus

(75) Inventor: Akira Sakamoto, Osaka-shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka-shi (JP)

(21) Appl. No.: 12/659,001

(22) Filed: Feb. 23, 2010

(30) Foreign Application Priority Data
Feb. 24, 2009 (JP) 2009-041149

(51) Int. Cl. G06F 15/00; G06F 17/00; G06F 9/46

(52) U.S. Cl. 715/274; 358/1.15; 718/100

(57) ABSTRACT

A control apparatus of the present invention is a control apparatus (i) which controls an image output apparatus that executes a job of outputting an image and a process of displaying a preview of the image on a display section, (ii) which is capable of causing the job to enter a hold state and releasing the job from the hold state, and (iii) which causes the image output apparatus to execute a job that is not in the hold state, in priority to a job in the hold state. The control apparatus includes a job controlling section which selects a control process from a first control process of causing the image output apparatus to execute a job corresponding to a preview displayed on the display section and a second control process of causing the job corresponding to the preview displayed on the display section to enter the hold state, and which performs the selected control process when no operation is performed to the image output apparatus for a predetermined time while the preview is being displayed. This can restrain a decrease in efficiency of an image output apparatus capable of displaying a preview.

This Nonprovisional application claims priority under 35 U.S.C. §119(a) on Patent Application No. 2009-041149 filed in Japan on Feb. 24, 2009, the entire contents of which are hereby incorporated by reference.

### TECHNICAL FIELD

The present invention relates to an image output apparatus capable of displaying a preview (thumbnail) of an image to be subjected to an output process, and a control apparatus for controlling the image output apparatus.

### BACKGROUND ART

Image output apparatuses, such as copying machines and multifunction printers perform image processing on an image to be printed, in accordance with the type of document and the setting conditions (e.g., print density, enlarging/reducing ratio, single-side printing/duplex printing, margin size). Furthermore, after the image processing, some image output apparatuses causes a display device to display a preview of the image to be printed, and then perform a printing process. It should be noted that the preview display takes the form of a page-by-page display of each image to be printed or a simultaneous display of pages of images to be printed.

Patent Literature 1 discloses an image forming apparatus having a function of performing no-operation-period processing when a user does not perform any operation for a predetermined time; and a function of restricting the no-operation-period processing during a time from receipt of an instruction of a preview display until the performing of the preview display. The no-operation-period processing disclosed in Patent Literature 1 means a process of initializing a content to be displayed as a preview, a process of shifting an operation mode of the image forming apparatus to a prewarming mode, and a process of turning off the power of the image forming apparatus. The image forming apparatus disclosed in Patent Literature 1 is aimed at restraining such an inconvenience that the no-operation-period processing is performed at the time of displaying a preview. According to the arrangement of Patent Literature 1, when the user does not perform any operation for a predetermined time before the preview display is performed, a content to be displayed as a preview is initialized. In this case, there occurs such a problem that the user should scan a document again by the image forming apparatus. This is troublesome for the user.

### Citation List

### Patent Literature 1

Japanese Patent Application Publication, Tokukai, No. 2006-333186 A (Publication Date: Dec. 7, 2006)

### SUMMARY OF INVENTION

### Technical Problem

Further, an image output apparatus capable of displaying a preview of an image to be subjected to an output process (a printing process, a transmission process) displays the preview of the image in response to receipt of a display command from a user, and performs the output process of the image in response to receipt of an output command from the user. Therefore, if no user operation is performed while the preview of the image to be subjected to the output process is being displayed, the output process is kept undone endlessly.

If the output process with respect to the preview is kept undone endlessly as such with the preview being displayed, another user, who is a different person from the user who inputted a job of the above output process, cannot use (operate) the image output apparatus. This causes a problem that efficiency (operation rate) of the image output apparatus decreases. Examples of such a situation that no user operation is performed with the preview being displayed may be as follows: (a) a case in which a user does not know which process he/she should select, because he/she is unfamiliar with the operation; and (b) a case in which a user is called out by someone when he/she operates the image output apparatus in the office, and leaves temporarily from the image output apparatus.

An object of the present invention is to restrain a decrease in efficiency of an image output apparatus having a function capable of displaying a preview of an image to be subjected to an output process.

### Solution to Problem

In order to achieve the above object, a control apparatus of the present invention is a control apparatus (i) which controls an image output apparatus that executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, and the control apparatus of the present invention includes a job controlling section which selects a control process from a first control process of causing the image output apparatus to execute a job corresponding to a preview displayed on the display section and a second control process of causing the job corresponding to the preview displayed on the display section to enter the hold state, and which performs the selected control process when no operation is performed to the image output apparatus for a predetermined time while the preview is being displayed.

In the above arrangement of the present invention, even if a use does not perform any operation with a preview being displayed, when a predetermined time elapses, a job of outputting an image of the displayed preview is forcibly executed or the job forcibly enters the hold state. Accordingly, with the above arrangement of the present invention, it is possible for another user, different from the user who inputted the job, to use the image output apparatus. This yields an effect that a decrease in efficiency of the image output apparatus can be restrained.

Further, in order to achieve the above object, a control apparatus of the present invention is a control apparatus which controls an image output apparatus that executes a job of outputting an image and a process of displaying a preview of the image on a display section before the job is executed, and the control apparatus of the present invention includes a job controlling section which causes the image output apparatus to execute a job corresponding to a displayed preview when no operation is performed to the image output apparatus for a predetermined time while the preview is being displayed.

In the above arrangement of the present invention, even if the user does not perform any operation to the image output apparatus with a preview being displayed, when a predetermined time elapses, a job corresponding to the displayed preview is forcibly completed. Accordingly, with the above arrangement of the present invention, it is possible for another user, different from the user who inputted the job, to use the image output apparatus. This yields an effect that a decrease in efficiency of the image output apparatus can be restrained.

Furthermore, in order to achieve the above object, a control apparatus of the present invention is a control apparatus (i) which controls an image output apparatus which executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, and the control apparatus of the present invention includes a job controlling section which causes a job corresponding to a preview displayed on the display section to enter the hold state when no operation is performed to the image output apparatus for a predetermined time while the preview is being displayed.

In the above arrangement of the present invention, even if the user does not perform any operation to the image output apparatus with a preview being displayed, when a predetermined time elapses, a job corresponding to the displayed preview forcibly enters the hold state. Accordingly, with the above arrangement of the present invention, it is possible for another user, different from the user who inputted the job, to use the image output apparatus. This yields an effect that a decrease in efficiency of the image output apparatus can be restrained.

### ADVANTAGEOUS EFFECTS OF INVENTION

With the present invention, it is advantageously possible to restrain that jobs are retained in an image output apparatus and to restrain a decrease in efficiency of the image output apparatus.

### BRIEF DESCRIPTION OF DRAWINGS

FIG. 1 is a block diagram schematically showing an arrangement of a multifunction printer as one embodiment of an image output apparatus of the present invention.

FIG. 2 (a) of FIG. 2 shows an image of a notification message that notifies forcible printing. (b) of FIG. 2 shows an image of a message that notifies that a job is to forcibly enter a hold state.

FIG. 3 is a flowchart showing the flow of a process according to Embodiment 1 of the present invention.

FIG. 4 is a view showing an example of a job list.

FIG. 5 is a flowchart showing the flow of a process according to Embodiment 2 of the present invention.

FIG. 6 is a view showing an example of a condition/process table used in Embodiment 3 of the present invention.

FIG. 7 is a flowchart showing the flow of a process according to Embodiment 3 of the present invention.

FIG. 8 is a block diagram showing an image forming apparatus of a reference example and showing the flow of image data in a printing process in a copy mode and a full-color mode.

FIG. 9 shows block diagrams each showing a part inside of an image processing apparatus of the reference example. (a) of FIG. 9 shows a part inside of the image processing apparatus at the time of performing a printing process in the copy mode and a single-color mode. (b) of FIG. 9 shows a part inside of the image processing apparatus at the time of performing a printing process in the copy mode and a two-color mode.

FIG. 10 is a block diagram showing the image forming apparatus of the reference example and showing the flow of image data in a preview display process in the copy mode and the full-color mode.

FIG. 11 shows block diagrams each showing a part inside of the image processing apparatus of the reference example. (a) of FIG. 11 shows a part inside of the image processing apparatus at the time of performing a preview display in the copy mode and the singe-color mode. (b) of FIG. 11 shows a part inside of the image processing apparatus at the time of performing a preview display in the copy mode and the two-color mode.

FIG. 12 shows gamma curves. (a) of FIG. 12 shows an example of a gamma curve corresponding to the display characteristics of an image display device. (b) of FIG. 12 shows a solid line representing a gamma curve for texts to be sharply displayed and a dotted line representing a gamma curve corresponding to the display characteristics of the image display device.

FIG. 13 is a flowchart showing steps of a process that is performed by the image forming apparatus of the reference example in the copy mode and the full-color mode.

FIG. 14 is a block diagram showing the image forming apparatus of the reference example and showing the flow of image data in a transmission process in a facsimile transmission mode.

FIG. 15 is a block diagram showing the image forming apparatus of the reference example and showing the flow of image data in a preview display process in the facsimile transmission mode.

FIG. 16 is a block diagram showing the image forming apparatus of the reference example and showing the flow of image data in a printing process in a facsimile reception mode.

FIG. 17 is a block diagram showing the image forming apparatus of the reference example and showing the flow of image data in a preview display process in the facsimile reception mode.

FIG. 18 is a block diagram showing a modified example of the image forming apparatus of the reference example and showing an image forming apparatus.

### DESCRIPTION OF EMBODIMENTS

### Embodiment 1

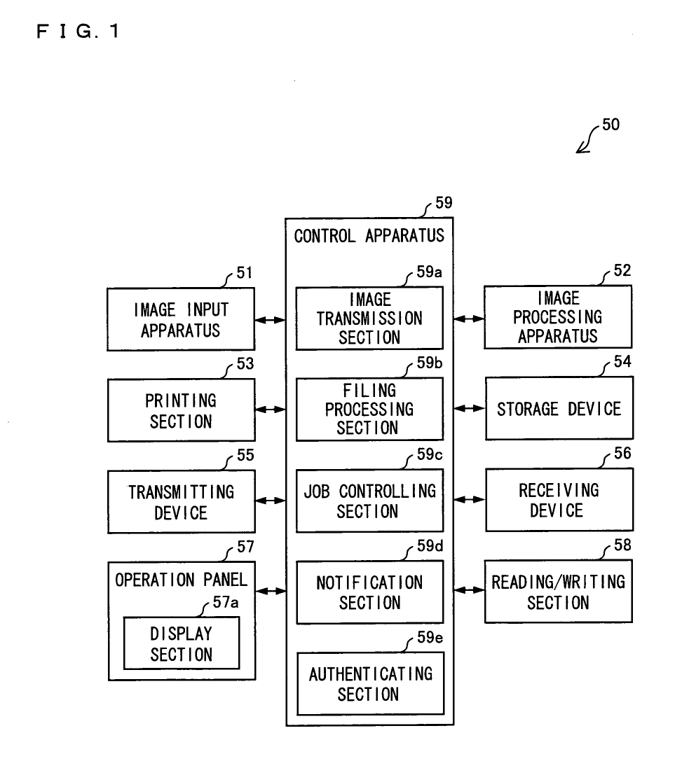

One embodiment of the present invention is described below with reference to attached drawings. FIG. 1 is a block diagram schematically showing an arrangement of a multifunction printer of the present embodiment.

A multifunction printer 50 is an image output apparatus that executes a job of outputting an image of image data. It should be noted here that the job to be executed by the multifunction printer 50 indicates an output process, such as a printing process, a transmission process, or a filing process.

More specifically, the printing process indicates a printing process in a copy mode, a printing process in a print mode, or a printing process in a facsimile reception mode. The copy mode means a mode in which the multifunction printer 50 reads image data and then prints an image of the image data. The print mode means a mode in which the multifunction printer 50 receives image data from a terminal device (not shown) and prints an image of the image data. The facsimile reception mode means a mode in which the multifunction printer 50 receives image data by facsimile and then prints an image of the image data.

Further, the transmission process indicates a transmission process in a facsimile transmission mode or a transmission process in an image transmission mode. The facsimile transmission mode means a mode in which the multifunction printer 50 reads image data and then transmits an image of the image data to an external apparatus by facsimile. The image transmission mode means a mode in which the multifunction printer 50 reads image data and then transmits an image of the image data to a destination that a user specifies. The destination in the image transmission mode may be, for example, an address and a folder on a network to which the multifunction printer is connected, and a USB memory (USB flash drive) mounted in the multifunction printer 50.

Further, the filing process indicates a process in which, in the copy mode, the facsimile transmission mode, or the like mode, to generate an image file in a predetermined file format from an image to be printed or transmitted, and to store the image file.

As shown in FIG. 1, the multifunction printer 50 includes an image input apparatus 51, an image processing apparatus 52, a printing section 53, a storage device 54, a transmitting device 55, a receiving device 56, an operation panel 57, a reading/writing section 58, and a control apparatus 59.

The image input apparatus 51 is image scanning means for generating image data by scanning a document. More specifically, the image input apparatus 51, which includes a scanner section having a CCD (charge-coupled device), generates image data showing an image of a document, based on light reflected by the document.

The image processing apparatus 52 is an integrated circuit, constituted by an ASIC (application specific integrated circuit), which performs image processing on image data sent from outside or image data generated by the image input apparatus 51.

The printing section 53 prints (outputs), onto a recording medium (e.g., a sheet of paper), an image of image data having been subjected to image processing in the image processing apparatus 102. An example is an electrophotographic or ink-jet color printer.

The storage device 54 is a hard disk device in which to temporarily store image data to be processed in the multifunction printer 50 or data of a job executed by the multifunction printer 50.

The transmitting device 55 is a device (e.g., modem), connected to a telephone line or the Internet, which transmits, to an external apparatus by facsimile communication, an image of image data inputted into the image input apparatus 51 and processed by the image processing apparatus 52. The receiving device 56 is a device (e.g., modem), connected to a telephone line or the Internet, which receives image data from an external apparatus by facsimile communication.

The operation panel 57 is a user interface from which a user inputs various commands or various settings to operate the multifunction printer 50. The operation panel 57 is provided with a group of buttons for input and setting, and a display section 57a.

The display section 57a is a liquid crystal display capable of displaying a color image, and displays various kinds of information related to the multifunction printer 50. Further, the display section 57a, covered with a touch panel, functions as an input interface of the multifunction printer 50. That is, the display section 57a displays a GUI (graphical user interface) for operation, such as input of various commands to the multifunction printer 50, and an operation guide.

The reading/writing section 58 is a reader/writer that performs a process of writing a user ID in a noncontact IC card (hereinafter just referred to as “IC card”) of a user at the time of registering the user ID and a process of reading a user ID from an IC card of a user at the time of authenticating the user. One of the examples of the IC card is Felica (registered trademark). It should be noted that, in the present embodiment, the reading/writing section 58 may not be provided especially.

The control apparatus 59 is a computer including a processor such as a CPU (central processing unit) or a DSP (digital signal processor). The control apparatus 59 controls various types of hardware provided in the multifunction printer 50 and controls data transfer between pieces of hardware, thereby controlling operation of the multifunction printer 50.

More specifically, the control apparatus 59 causes the multifunction printer 50 to perform a process in the copy mode, the print mode, the facsimile transmission mode, the facsimile reception mode, or the image transmission mode, each described above, in accordance with a command inputted by the user.

That is, in the copy mode, the control apparatus 59 causes the image input apparatus 51 to read image data, the storage device 54 to temporarily store the image data therein, and then the printing section 53 to print an image of the image data. Further, in the print mode, the control apparatus 59 causes the storage device 54 to temporarily store image data received from a terminal device and the printing section 53 to print an image of the image data. Moreover, in the facsimile transmission mode, the control apparatus 59 causes the image input apparatus 51 to read image data, the storage device 54 to temporarily store the image data therein, and then the transmitting device 55 to transmit an image of the image data. Furthermore, in the facsimile reception mode, the control apparatus 59 causes the receiving device 56 to receive image data, the storage device 54 to temporarily store the image data therein, and then the printing section 53 to print an image of the image data.

Further, as shown in FIG. 1, the control apparatus 59 includes an image transmitting section 59a, a filing processing section 59b, a job controlling section 59c, a notification (announcement) section 59d, and an authenticating section 59e.

In the image transmission mode, the image transmitting section 59a is a block that performs a process of (i) causing the image input apparatus 51 to read image data and the storage device 54 to temporarily store the image data therein, and then (ii) transmitting an image of the image data to a specified destination. In a case where the image transmitting section 59a transmits an image to an address on a network, the image transmitting section 59a attaches, to an e-mail, the image to be transmitted, and then transmits the e-mail to the address.

The filing processing section 59b is a block that performs, in any one of the aforementioned modes, a process of (i) generating an image file (JPEG file, TIFF file, or the like) in a predetermined file format from an image to be printed or transmitted, in accordance with a command from the user, and then (ii) causing the storage device 54 to store the generated image file therein.

In cases where a preview command is inputted or “Preview Display: Yes” is set in the copy mode, the facsimile transmission mode, the facsimile reception mode, or the image transmission mode, the job controlling section 59c causes the display section 57a to display a preview of an image to be subjected to an output process, such as printing, transmission, or filing, before the output process is performed.

The following deals with the preview more specifically. For a preview display in the copy mode, the facsimile transmission mode, or the image transmission mode, the user initially sets “Preview Display: Yes” and then inputs a start command. This causes the image input apparatus 51 to read image data, the storage device 54 to store the image data therein, and then the display section 57a to display a preview of an image of the image data stored in the storage device 54. In response to user input of an output command during the preview display, the image of the image data stored in the storage device 54 is printed or transmitted.

For a preview display in the facsimile reception mode, the user checks that received image data is stored in the storage device 54 and then inputs a preview command so that a preview of an image of the received image data stored in the storage device 54 is displayed on the display section 57a. Then, in response to user input of an output command during the preview display, the image of the received image data stored in the storage device 54 is printed.

Further, in the copy mode, the facsimile transmission mode, or the like mode, in cases where the user selects execution of filing in advance, not only a printing or transmitting process, but also a filing process is performed in response to user input of an output command during the preview display.

In any of the aforementioned modes, image data is subjected to image processing by the image processing apparatus 52 and then supplied to the display section 57a. Further, in any of the aforementioned modes, after image data is subjected image processing by the image processing apparatus 52, the image data is supplied to a section (device), such as the printing section 53, the transmitting device 55, or the image transmitting section 59a, in which an output process is performed.

Further, in cases where the user does not input any operation to the multifunction printer 50 for a predetermined time while a preview is displayed on the display section 57a, the job controlling section 59c controls the multifunction printer 50 to perform an output process (printing, transmitting, or filing) on an image of the displayed preview. Such a situation in which the user does not input any operation to the multifunction printer 50 indicates a situation in which the user does not operate the operation panel 57.

More specifically, in the copy mode or the facsimile reception mode, when the user does not perform any operation to the multifunction printer 50 for a predetermined time while a preview is displayed, the job controlling section 59c causes the printing section 53 to print an image of image data to be processed in the copy mode or the facsimile reception mode, even if the user does not input any command. Further, in the facsimile transmission mode, when the user does not perform any operation to the multifunction printer 50 for a predetermined time while a preview is displayed, the job controlling section 59c causes the transmitting device 55 to transmit an image of image data to be processed. Moreover, in the image transmission mode, when the user does not perform any operation to the multifunction printer 50 for a predetermined time, the job controlling section 59c causes the image transmitting section 59a to transmit an image of image data to be transmitted, even if the user does not input any command.

In the copy mode, the facsimile transmission mode, or the like mode, in cases where the user selects a filing process in advance, if the user does not perform any operation to the multifunction printer 50 for a predetermined time, an image of image data is not only printed or transmitted but also filed.

Hereinafter, such printing or transmitting that is performed when no user operation is performed for a predetermined time during a preview display is referred to as an automatic output (forcible output).

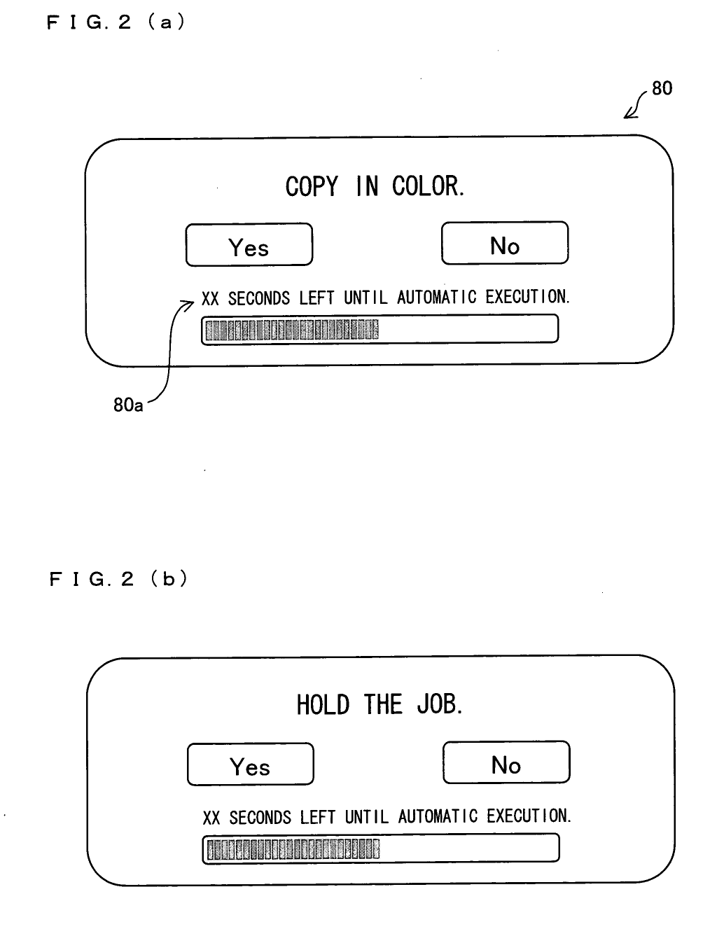

The notification section 59d causes the display section 57a to display a message that notifies (announces) that an automatic output is to be performed, before the automatic output. (a) of FIG. 2 shows an image displayed on the display section 57a by the notification section 59d. The image shows a message notifying that an automatic output (printing) is to be performed in the copy mode.

In (a) of FIG. 2, a message indicated by a reference sign 80a is the message notifying an automatic output. Further, the message also shows a remaining time left before the automatic output. A value of the displayed remaining time is decremented as time passes. Further, in the image of (a) of FIG. 2, a meter indicative of the remaining time left before the automatic output is also displayed so that the user can easily know how much time is left. Moreover, in the image of (a) of FIG. 2, a “Yes” button for inputting an output command (printing command) and a “No” button for inputting a cancel command are also shown.

In the image of (a) of FIG. 2, the value of the remaining time is decremented as time passes. However, such an embodiment may be also possible that a message simply indicating that “an automatic execution will be performed if no key operation is inputted for ten seconds” may be displayed. That is, a value of time to be displayed may be fixed without decrement.

The authenticating section 59e is a block that performs user authentication by use of a user ID read from an IC card by the reading/writing section 58 and a password inputted from the operation panel 57. In the present embodiment, the authenticating section 59e may not be provided especially, similarly to the reading/writing section 58.

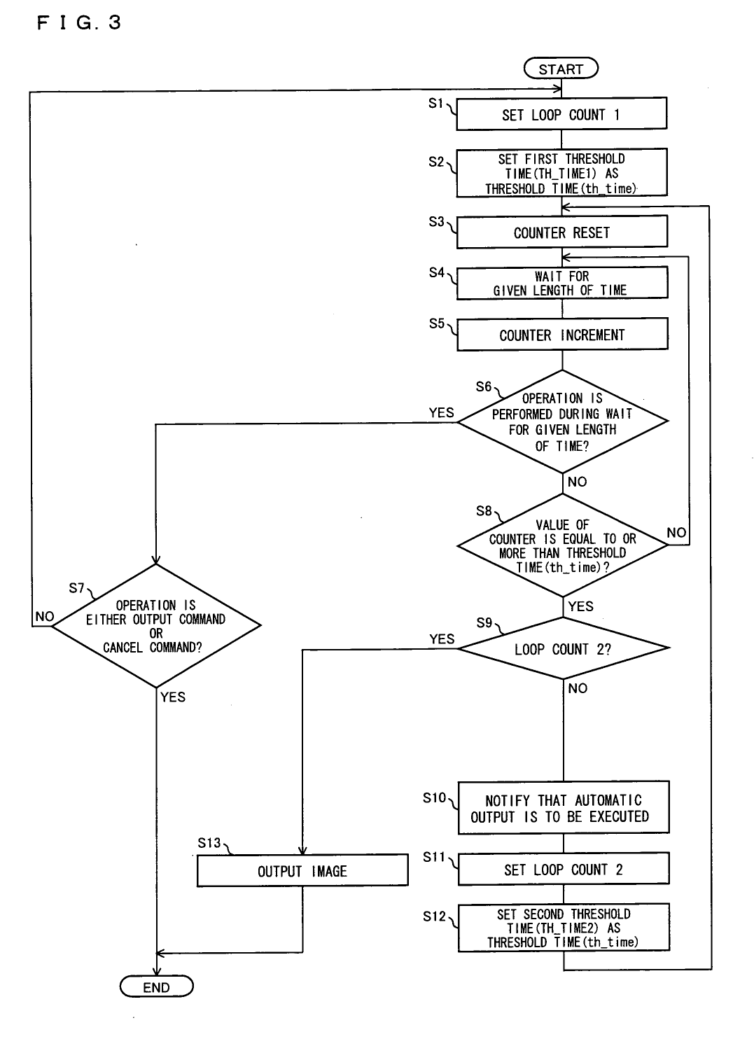

With reference to FIG. 3, the following describes an automatic output executed by the job controlling section 59c more specifically. FIG. 3 is a flowchart showing the flow of a process in the job controlling section 59c. The following explains about FIG. 3 by taking, as an example, an automatic output in the copy mode.

In the copy mode, when a preview display of an image to be outputted (printed) is initiated, the job controlling section 59c sets a loop count 1 (normal state) (S1), sets a first threshold time as a threshold time (S2), and resets a counter (S3). After the job controlling section 59c stands by for a given length of time (S4), the job controlling section 59c increments the counter by a value of the given length of time (S5). In the present embodiment, the first threshold time is 60 seconds and the given length of time is 0.01 second. However, the first threshold time and the given length of time are not limited to these values.

If the user operates the operation panel 57 and inputs an output command during the standby in S4 (YES in S6 and YES in S7), the job controlling section 59c causes the printing section 53 to output (print) an image of a displayed preview, so as to complete a job. Meanwhile, if the user operates the operation panel 57 and inputs a cancel command during the standby in S4 (YES in S6 and YES in S7), the job controlling section 59c cancels the job without causing the printing section 53 to output (print) the image. The job controlling section 59c also terminates the preview display at the time of canceling the job.

Furthermore, if the user inputs, from the operation panel 57, an operation other than the output command and the cancel command, the process of the job controlling section 59c returns to S1 (YES in S6 and NO in S7).

In contrast, if the user does not input any operation during the standby in S4 (NO in S6), the job controlling section 59c judges whether or not the value of the counter is equal to or more than the threshold time (S8). If the value of the counter is not equal to or more than the threshold time (NO in S8), the process of the job controlling section 59c returns to S4.

When the value of the counter becomes equal to or more than the threshold time (YES in S8) by repeatedly performing the steps S4 through S6, and the step S8, the job controlling section 59c judges whether or not a loop count 2 (output check state) is set (S9).

When the process reaches to S9 for the first time, not the loop count 2 but the loop count 1 is set. Therefore, as shown in FIG. 3, the process of the job controlling section 59c proceeds to S10. In S10, the job controlling section 59c gives an instruction to the notification section 59d so that the notification section 59d that has received the instruction causes the display section 57a to display the image shown in (a) of FIG. 2. Thus, the user is notified that an automatic printing is to be executed later. The remaining time to be displayed in the image of (a) of FIG. 2 is a second threshold time, which is to be set in the after-mentioned step S12. The second threshold time is 10 seconds. Note however that the second threshold time is not limited to 10 seconds, and can be altered.

After S10, the job controlling section 59c cancels the setting of the loop count 1 and sets the loop count 2 (S11).

After S11, the job controlling section 59c cancels the setting of the first threshold time and sets a second threshold time as a threshold time (S12). Then, the process of the job controlling section 59c returns to S3 in which the counter is reset. After that, the steps S4 through S8 are performed. In such a state where the loop count 2 is set, the notification section 59d decrements the remaining time shown in the image of (a) of FIG. 2 as time passes.

When the value of the counter becomes equal to or more than the threshold time (YES in S8) by repeatedly performing the steps S4 through S6, and the step S8, the job controlling section 59c judges whether or not the loop count 2 (output check state) is set (S9). When the process reaches to S9 for the second time, the loop count 2 is set. Therefore, as shown in FIG. 3, the process of the job controlling section 59c proceeds to S13. In S13, the job controlling section 59c causes the printing section 53 to output (print) an image of a displayed preview, without receiving any output command from the user, so as to complete the job. Further, the job controlling section 59c also terminates the preview display at the time of completing the job.

The above description dealt with the process shown in FIG. 3 by taking an output process (printing process) in the copy mode as an example. However, the process in FIG. 3 may be also applied to an output process (printing) in the facsimile reception mode, an output process (transmission) in the facsimile transmission mode, and an output process (transmission) in the image transmission mode.

It should be noted that in the output process in the facsimile transmission mode or the image transmission mode, an image to be displayed as a preview is an image to be transmitted. Further, in this case, if the user operates the operation panel 57 and inputs an output command during the standby in S4 (YES in S6 and YES in S7), the job controlling section 59c causes the transmitting device 55 or the image transmitting section 59a to perform a transmission process (output process). Further, in S13, the job controlling section 59c causes the transmitting device 55 or the image transmitting section 59a to transmit an image of a displayed preview, without receiving any output command from the user.

In the process shown in FIG. 3, in cases where a total time of the first threshold time and the second threshold time is taken as a predetermined time, if no user operation is performed for the predetermined time while a preview is displayed on the display section 57a, the job controlling section 59c causes the multifunction printer 50 to execute a job of outputting an image of the displayed preview (S13). Therefore, even if the user does not perform any operation for a while with the preview being displayed, when the predetermined time elapses, a job corresponding to the displayed preview is forcibly executed. This allows another user, different from the user who inputted the job, to use the multifunction printer 50. This yields an effect that a decrease in efficiency of the multifunction printer 50 can be restrained.

Further, it is not preferable that a preview is kept displayed for a long time, from the viewpoint of security. In terms of this, according to the process of the present embodiment, if the user does not perform any operation for the predetermined time while a preview is being displayed, a job is forcibly executed and the preview display is terminated. This can restrain the above problem that the preview is kept displayed for a long time.

Furthermore, most multifunction printers having a preview function are designed such that in cases where copying is performed without using a preview function, one command input doubles as a scan instruction and a printing instruction, and in cases where copying is performed with a preview being displayed, a start command (scan instruction) and an output command (printing command) should be inputted separately. This may cause such a problem that a user who does not know that he/she should input two commands at the time of using the preview function (i.e., a user unfamiliar with the operation) is bewildered with a preview being displayed, because he/she has no idea what to do next after displaying the preview. In view of this, according to the process of the present embodiment, even if the user inputs only one command, a job is to be executed forcibly after a predetermined time passes. This prevents the above problem.

Further, in the present embodiment, when no user operation is performed for the first threshold time, which is shorter than the predetermined time, the notification section 59d notifies the user that an output process with respect to an image of a displayed preview is to be performed forcibly. After the notification section 59d notifies the user as such, the job controlling section 59c causes the multifunction printer 50 to perform an output process on the image of the displayed preview. This can prevent such a problem that a job is forcibly executed unexpectedly for the user. That is, the user who does not want forcible execution of a job can take measures to stop the forcible execution. For example, in FIG. 3, it is possible to prevent the forcible execution by inputting a cancel command or by performing any operation. Further, by performing any operation (NO in S7), it is possible for the user to continuously check a content of a preview.

Further, the notification by the notification section 59d may not be performed, particularly. The following describes this point more specifically. In FIG. 3, the process is set such that the steps S1, S2, and S9 through S12 are not performed, and in cases of YES in S8, the process proceeds to S13. Even in this case, if no user operation is performed for a predetermined time (the threshold time of S8) while a preview is displayed on the display section 57a, the job controlling section 59c causes the multifunction printer 50 to execute a job of outputting an image of the displayed preview.

In normal multifunction printers having a preview function, while a preview is displayed, a scan process cannot be performed. Therefore, it is impossible to receive jobs in the copy mode, the facsimile transmission mode, and the image transmission mode, although it is still possible, in the print mode, to receive data and perform a printing process on the data during the preview display, and further, it is also possible, in the facsimile reception mode, to receive data during the preview display. For this reason, in cases where a preview is being displayed and a job corresponding to the preview remains undone, another user, different from the user who inputted the job, cannot input any other job in the copy mode, the facsimile transmission mode, or the image transmission mode. This causes a decrease in efficiency of the multifunction printer. In contrast, in the multifunction printer 50 of the present embodiment, if the user does not perform any operation while a preview is displayed, a job corresponding to the displayed preview is forcibly executed. This allows another user, different from the user who inputted the job, to operate the image input apparatus 51 so as to input a job in any of the copy mode, the facsimile transmission mode, and the image transmission mode. This yield an effect that the multifunction printer 50 of the present embodiment can restrain a decrease in efficiency, which decrease usually occurs due to continuous display of a preview.

### Embodiment 2

Embodiment 1 is such that if no user operation is performed to the multifunction printer 50 for a predetermined time with a preview being displayed on the display section 57a, the job controlling section 59c causes the multifunction printer 50 to execute a job of outputting an image of the preview.

However, the job controlling section 59c is not limited to the aforementioned embodiment. For example, the job controlling section 59c may be arranged such that if no use operation is performed to the multifunction printer 50 for a predetermined time with a preview being displayed on the display section 57a, the job controlling section 59c may hold a job of outputting an image of the preview. The present embodiment deals with such an embodiment of the job controlling section 59c. Each member in the present embodiment having the same reference sign as a corresponding member in Embodiment 1 has the same function as that in Embodiment 1, if there is not any particular explanation.

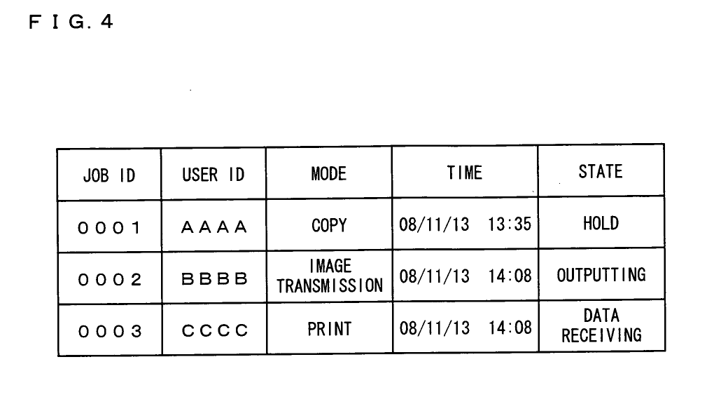

In the present embodiment, a job inputted into the multifunction printer 50 is registered in a job list shown in FIG. 4, so that the control apparatus 59 controls execution of a job based on the job list. As shown in FIG. 4, the job list shows data (hereinafter referred to as “job data”) of each job inputted into the multifunction printer 50. The job data includes a job ID, a user ID, a mode, a time, and a state. The job ID is identification information of a job; the user ID is identification information of a user who inputs the job; the mode indicates a type of the job; the time indicates a time when the job data is inputted (or a setting time); and the state indicates a state of the job. The time may be a final update time (for a hold job, a time when the job entered a hold state, and for a job being outputted, a time to be updated at predetermined intervals).

Further, as the job state, there are an output state, a wait state, a receiving state, and a hold state. In FIG. 4, the output state is represented by “outputting”, the receiving state is represented by “data receiving”, and the hold state is represented by “hold”. Further, in FIG. 4, a job in the wait state is not listed in the job list, but the wait state is represented by “waiting” in the job list.

The output state indicates a state in which an output process is being performed. The wait state indicates a state in which a job is waiting for outputting because there is another job in the output state. That is, the job in the wait state enters the output state subsequently after the another job in the output state, different from the job in the wait state, is completed. In cases where there are a plurality of jobs in the wait state, the plurality of jobs sequentially enters the output state in the order of inputting.

The receiving state indicates a state in which image data necessary for a job to be executed is being received. That is, the receiving state indicates a state in which image data is being received in the print mode or the facsimile reception mode. When the data reception is completed, the job in the receiving state enters any of the output state, the wait state, and the hold state.

The hold state indicates a state in which execution of a job is suspended. The hold state is set in response to user input of a hold command. Further, the hold state is also set if no user operation is performed for a predetermined time with a preview being displayed. Further, a job in the facsimile reception mode may be set to enter the hold state after the receiving state. In the present embodiment, an image (see (b) of FIG. 2) for inputting a hold command is automatically displayed at a predetermined timing during the preview display.

The job in the hold state is not executed, but job data and image data of the job are maintained in the storage device 54. Upon receiving a command from the user, the job is released from the hold state. The job released from the hold state then enters the output state or the wait state.

Further, in the present embodiment, in cases where a job has entered the hold state, an e-mail that notifies that the job has entered the hold state is sent to a user who inputted the job. The following describes how to send the e-mail. In the present embodiment, a user ID of the user, a password of the user, and a mail address of the user are stored in the storage device 54 in association with each other. When using the multifunction printer 50, the user inputs the password from the operation panel 57 and scans his/her IC card by the reading/writing section (a receiving section) 58 so that a user ID stored in the IC card is read out. Following that, the authenticating section 59e performs user authentication by use of the user ID and the password. If a combination of the inputted password and the read user ID is identical with a combination of the password and the user ID stored in the storage device 54, the authenticating section 59e judges that the user who inputted the password is an authentic user. Further, when the user operates the multifunction printer 50 and inputs a job, job data is formed based on the user ID of the user. After the job enters the hold state, a mail processing section (not shown) reads out, from the storage device 54, a mail address that is stored in the storage device 54 in association with the user ID in the job data of the job, and then sends the aforementioned e-mail to the mail address. Thus, the e-mail that notifies that the job has entered the hold state is sent to the user who inputted the job.

Although it is not described in Embodiment 1, it may be also possible in Embodiment 1 that in cases where a job has been executed forcibly, an e-mail that notifies that the job has been executed may be sent to a mail address of a user who inputted the job. That is, Embodiment 1 may be arranged such that user authentication is performed in the same manner as in the present embodiment, and the mail processing section reads out a mail address from the storage device 54 in the same manner as in the present embodiment after S13 in FIG. 3, so that the e-mail is sent to the mail address.

Next will be described the job controlling section 59c according to the present embodiment. Similarly to Embodiment 1, the job controlling section 59c according to the present embodiment has a function of causing the display section 57a to display a preview of an image to be subjected to an output process, such as printing, transmitting, or filing, in the copy mode, the facsimile transmission mode, the facsimile reception mode, or the image transmission mode, before the output process is performed.

However, the job controlling section 59c according to the present embodiment does not cause the multifunction printer 50 to execute a job of outputting an image of a displayed preview in cases where no user operation is performed to the multifunction printer 50 for a predetermined time with the preview being displayed on the display section 57a. In such cases, the job controlling section 59c according to the present embodiment causes the job of outputting the image of the displayed preview to enter the hold state.

That is, in the copy mode, the facsimile reception mode, the facsimile transmission mode, or the image transmission mode, if the user does not perform any operation to the multifunction printer 50 for a predetermined time with a preview being displayed on the display section 57a, the job controlling section 59c forcibly causes a job of outputting (printing, transmitting) an image of the displayed preview, to enter the hold state. The job that has entered the hold state is to be shown as “hold” in the job list of FIG. 4.

Further, the notification section 59d according to the present embodiment displays, on the display section 57a, a message notifying that a job is to enter the hold state, before the job enters the hold state without receiving any command from the user. (b) of FIG. 2 shows an image displayed on the display section 57a by the notification section 59d, and the image shows a message that notifies that a job is to forcibly enter the hold state. In the image of (b) of FIG. 2, a “Yes” button for inputting a hold command and a “No” button for terminating the display of the image of (b) of FIG. 2 are also shown.

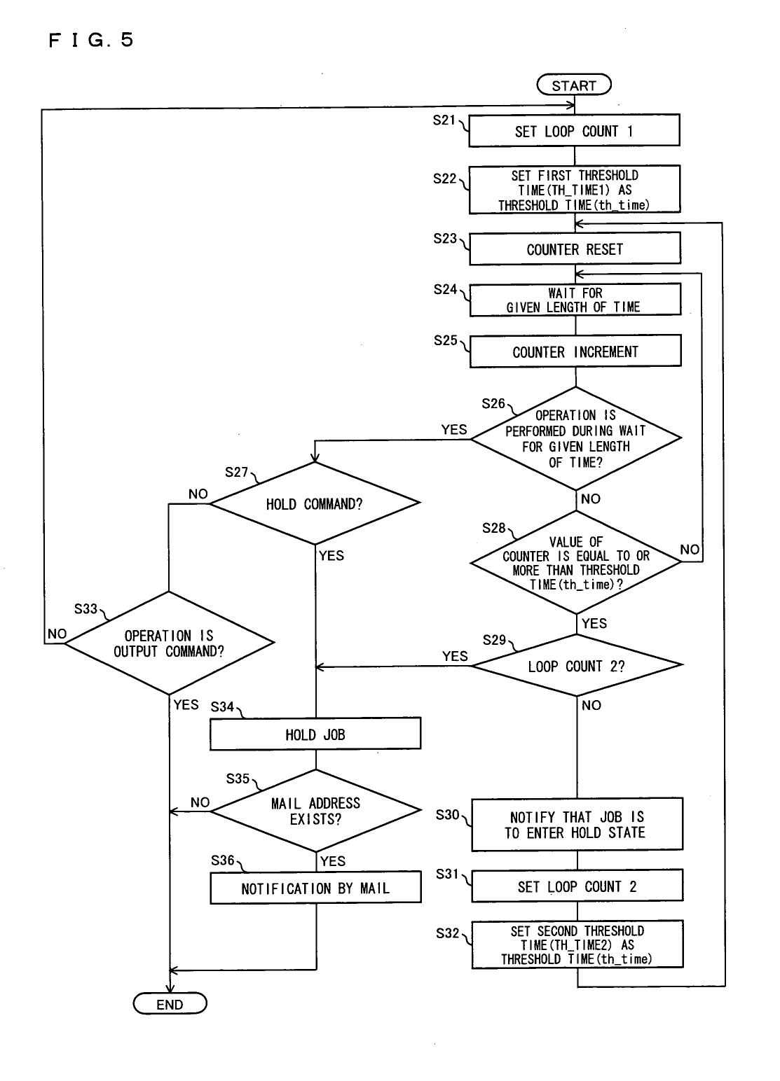

With reference to FIG. 5 explained is a process of the job controlling section 59c according to the present embodiment, more specifically. FIG. 5 is a flowchart showing the flow of a process of the job controlling section 59c in Embodiment 2. The following describes a detail of FIG. 5 by taking, as an example, a process in the copy mode.

Steps S21 through S26 in FIG. 5 are the same as the steps S1 through S6 in FIG. 3, respectively, and therefore are not described here. Further, a first threshold time in S22 is 60 seconds, which is the same as the first threshold time in S2, and a given length of time in S24 is 0.01 second, which is the same as the given length of time in S4. However, the first threshold time and the given length of time are not limited to these values.

If a user operates the operation panel 57 and inputs an output command during standby in S24 (YES in S26, NO in S27, and YES in S33), the job controlling section 59c causes the printing section 53 to output (print) an image of a displayed preview, so as to complete a job. The preview display is terminated at the time of completion of the job.

Further, if the user operates the operation panel 57 and inputs an operation other than an output command during the standby in S24, the process of the job controlling section 59c returns to S21 (YES in S26, NO in S27, and NO in S33).

If no user operation is performed during the standby in S24 (NO in S26), the job controlling section 59c judges whether or not a value of a counter is equal to or more than the threshold time (S28). If the value of the counter is not equal to or more than the threshold time (NO in S28), the process of the job controlling section 59c returns to S24.

When the value of the counter becomes equal to or more than the threshold time (YES in S28) by repeatedly performing the steps S24 through S26, and S28, the job controlling section 59c judges whether a loop count 2 (output check state) is set or not (S29). When the process reaches to S29 for the first time, not the loop count 2 but a loop count 1 is set. Therefore, as shown in FIG. 5, the process of the job controlling section 59c proceeds to S30.

In S30, the job controlling section 59c gives an instruction to the notification section 59d, and the notification section 59d that has received the instruction causes the display section 57a to display the image shown in (b) of FIG. 2. Thus, the user can be notified that the job is to forcibly enter the hold state later. Further, when the image shown in (b) of FIG. 2 is displayed in S30, the user can input a hold command. A remaining time to be displayed in the image shown in (b) of FIG. 2 is a second threshold time, which is to be set in the after-mentioned S32. The second threshold time herein is 10 seconds, which is the same as in Embodiment 1. It should be noted that the second threshold time is not limited to 10 seconds and may be altered.

After S30, the job controlling section 59c cancels the setting of the loop count 1 and sets the loop count 2 (S31). Further, the job controlling section 59c cancels the setting of the first threshold time and sets the second threshold time as the threshold time (S32). Then, the process of the job controlling section 59c returns to S23 in which the counter is reset. After that, the steps S24 through S28 are performed.

While the loop count 2 is set, the image of (b) of FIG. 2 is displayed on the display section 57a so that the user can input a hold command. Under such the condition where the loop count 2 is set, when the user inputs a hold command during the standby in S24 (YES in S26 and YES in S27), the job controlling section 59c causes a job of outputting (printing) an image of a displayed preview to enter the hold state (S34). After S34, a mail processing section (not shown) judges whether or not a mail address of the user of the job (hold job) in the hold state is stored in the storage device 54 (S35). If the mail address is stored (YES in S35), the mail processing section sends, to the mail address of the user of the hold job, an e-mail notifying that the job has entered the hold state (S36). The process is completed at the time of sending the e-mail. Further, if the mail address of the user of the hold job is not stored (NO in S35), the process is completed without sending the e-mail. At the time when the job has entered the hold state, a preview display for the job is terminated.

When the value of the counter becomes equal to or more than the threshold time (YES in S28) by repeatedly performing the steps S24 through S26, and the S28, the job controlling section 59c judges again whether the loop count 2 is set or not (S29). Since the loop count 2 has been already set when the process reaches to S29 for the second time, the process of the job controlling section 59 proceeds to S34, as shown in FIG. 5. The job controlling section 59c forcibly causes the job of outputting (printing) an image of the displayed preview to enter the hold state (S34), without receiving a hold command from the user. After that, if a mail address of the user has been stored, an e-mail is sent to the user and the process is completed. Meanwhile, if the mail address has not been stored, the process is completed without sending an e-mail to the user (S35, S36).

In the aforementioned process shown in FIG. 5, in cases where a total time of the first threshold time and the second threshold time is taken as a predetermined time, if no user operation is performed to the multifunction printer 50 for the predetermined time with a preview being displayed on the display section 57a, the job controlling section 59c causes a job of outputting an image of the displayed preview to enter the hold state (S34). On this account, even if the user does not perform any operation while a preview is displayed, when the predetermined time elapses, a job of outputting an image of the displayed preview forcibly enters the hold state. This allows another user, different from the user who inputted the job, to use the multifunction printer 50. This yields an effect that a decrease in efficiency of the multifunction printer 50 can be restrained.

Further, in cases where the user has no choice but to leave the multifunction printer 50 on urgent business while the multifunction printer 50 is performing a preview display, a job is forcibly held and the preview display is terminated. This can ensure security of a content of the job and further allows the user to resume an operation relevant to the job without inputting the job again (for example, rescanning).

Moreover, according to the procedure shown in FIG. 5, when no user operation is performed for the first threshold time, which is shorter than the predetermined time, the notification section 59d notifies the user that a job corresponding to a displayed preview is to enter the hold state. This yields an effect that it is possible to prevent that the job forcibly enters the hold state unexpectedly for the user. For example, for a user who does not want to hold a job but wants execution of the job (output), if the user inputs an output command, it is possible to prevent that the job is forcibly held.

The process in FIG. 5 is also applicable to an output process (printing) in the facsimile reception mode, an output process (transmission) in the facsimile transmission mode, and an output process (transmission) in the image transmission mode, similarly to the case of FIG. 3.

The above description dealt with a case where a mail notification to a user is set effective in the multifunction printer 50. In cases where a mail notification to a user is not set effective or the multifunction printer 50 does not have such a mail notification function, the process in FIG. 5 proceeds to END after S34, without proceeding to S35 and S36.

In the present embodiment, the notification section 59d may not perform notification, especially. In this case, the process in FIG. 5 is set such that the steps S21, S22, S27, and S29 through S32 are not performed, the process certainly proceeds to S34 in cases of YES in S28, and the process certainly proceeds to S33 in cases of YES in S26.

Further, in the above description, the image of (b) of FIG. 2 is displayed in S30 so that the user can input a hold command. However, the embodiment is not limited this. For example, a GUI for inputting a hold command may be displayed on the display section 57a together with a preview at the time of displaying the preview. In this case, it is possible for the user to input a hold command all the time while the preview is being displayed.

Further, a job having being held by the process in FIG. 5 is registered in a job list as a job in the hold state. When the user selects a job in the hold state from among jobs registered in the job list and then inputs a release command for releasing the selected job from the hold state and a preview command, the job controlling section 59c displays again, on the display section 57a, a preview of an image to be outputted in the job and resumes the process in FIG. 5.

For improvement in usability, when the user starts operating the multifunction printer 50, a job list consisting of jobs in the hold state at this point may be displayed on the display section 57a. A content to be displayed at this time may include a thumbnail of an image to be processed in each job (an image of a first page in a case where there are a plurality of pages), in addition to “mode” and “time” in FIG. 4. Further, filtering may be performed on the displayed list according to a mode or a time (for example, if “copy mode” may be selected as a filtering condition, jobs in modes other than the copy mode are delisted from the job list and information on the delisted jobs is not displayed).

It may be also possible to display a job list consisting of jobs in the hold state among jobs inputted by the user who operates the multifunction printer 50. The following described such an embodiment, more specifically. Initially, the user inputs a password and a user ID when using the multifunction printer 50. The authenticating section 59e performs user authentication by use of the inputted password and user ID. After the user authentication, the authenticating section 59e searches the storage device 54 for a job in the hold state that is associated with the inputted user ID. If there are any jobs in the hold state, associated with the inputted user ID, the authenticating section 59e displays a job list consisting of the jobs associated with the inputted user ID.

Further, when an e-mail notifying that a job has entered the hold state is sent in S36, the e-mail may also include a job ID of the job having entered the hold state. In this case, it may be also possible that, when the multifunction printer 50 receives a reply sent from the user in response to the e-mail, the job may be released from the hold state so that outputting is performed. Further, the user may access to the multifunction printer 50 via a network so that the user can refer to filing information and provides an instruction of outputting.

In addition, in FIG. 5, in cases where a job forcibly enters the hold state when the process proceeds from S29 to S34, the user may not recognize that the job has entered the hold state. In this case, such a hold job that the user does not recognize is accumulated in the storage device 54, thereby causing such a problem that the storage device 54 runs short of its capacity (normally, a job not in the hold state is deleted from the storage device 54 when the job is executed. However, a job in the hold state remains in the storage device 54 unless the user provides any instruction). In such a case, the job in the hold state may be set to be deleted from the storage device 54 after a predetermined period of time (for example, one day or one week) elapses.

However, since the process using such a job list is a little complicated, Embodiment 2 may be suited for a user familiar with the multifunction printer 50 (for example, a user working in the office where the multifunction printer 50 is placed). On the other hand, the process in Embodiment 1 is simpler than that in Embodiment 2, and therefore Embodiment 1 may be suited for a user unfamiliar with the multifunction printer 50.

### Embodiment 3

Embodiment 3 is such that: a control process is selected from a first control process and a second control process, which are described below, according to a content of a job corresponding to a preview displayed on the display section 57a; and when no user operation is performed to the multifunction printer 50 for a predetermined time with the preview being displayed on the display section 57a, the selected control process is performed.

The first control process: a process of causing the multifunction printer 50 to execute a job corresponding to a preview displayed on the display section 57a.
The second control process: a process of causing a job corresponding to a preview displayed on the display section 57a to enter the hold state.

In Embodiment 3, either a process in Embodiment 1 of causing the multifunction printer 50 to execute a job when no user operation is performed for a predetermined time with a preview being displayed, or a process in Embodiment 2 of holding a job when no user operation is performed for a predetermined time with a preview being displayed is selected and then performed. Each member in the present embodiment, having the same reference sign as a corresponding member in Embodiments 1 and 2, has the same function as that in Embodiments 1 and 2, if there is no particular explanation.

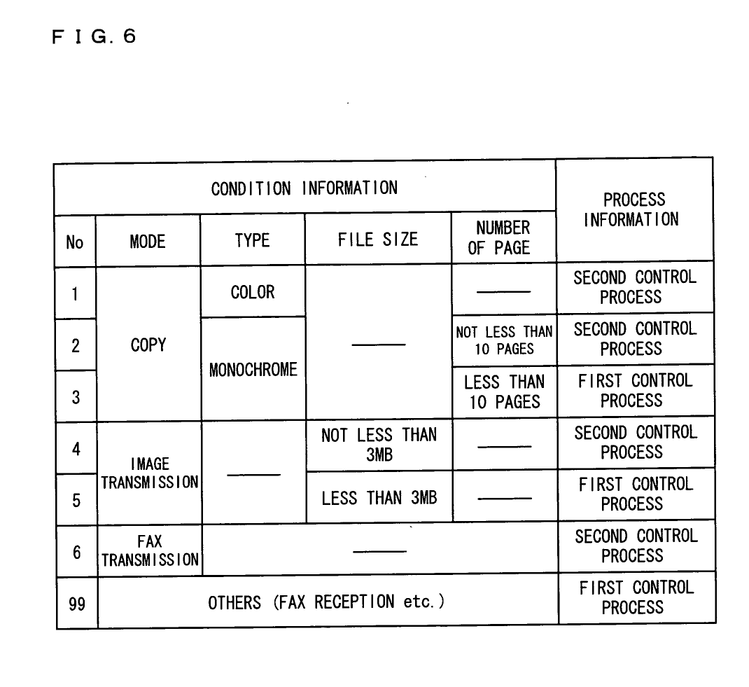

In the present embodiment, a condition/process table shown in FIG. 6 is stored in the storage device 54, in advance. The condition/process table is a table showing a correspondence relation between (i) condition information (content information) indicative of conditions of a job (a content of a job) and (ii) process information indicative of a control process suitable for the conditions of the job, as shown in FIG. 6. The process information indicates either the first control process or the second control process.

In the present embodiment, the job controlling section 59c accesses the storage device 54 and refers to the condition/process table so that the job controlling section 59c searches for a piece of condition information that matches for conditions of a job corresponding to a displayed preview and then detects a piece of process information that is associated with the piece of condition information that is found by the search. When no user operation is performed for a predetermined time with the preview being displayed on the display section 57a, the job controlling section 59c performs a control process indicated by the detected piece of process information.

That is, the job controlling section 59c selects either the first control process or the second control process as a control process suitable for a preview displayed on the display section 57a, by referring to the condition/process table of FIG. 6. Then, when no user operation is performed for a predetermined time with the preview being displayed on the display section 57a, the job controlling section 59c performs a selected control process.

According to FIG. 6, in cases where the job corresponding to the displayed preview is color printing in the copy mode, the job controlling section 59c selects the second control process. Further, in cases where the job corresponding to the displayed preview is monochrome printing in the copy mode and the number of pages to be printed is less than 10, the job controlling section 59c selects the first control process.

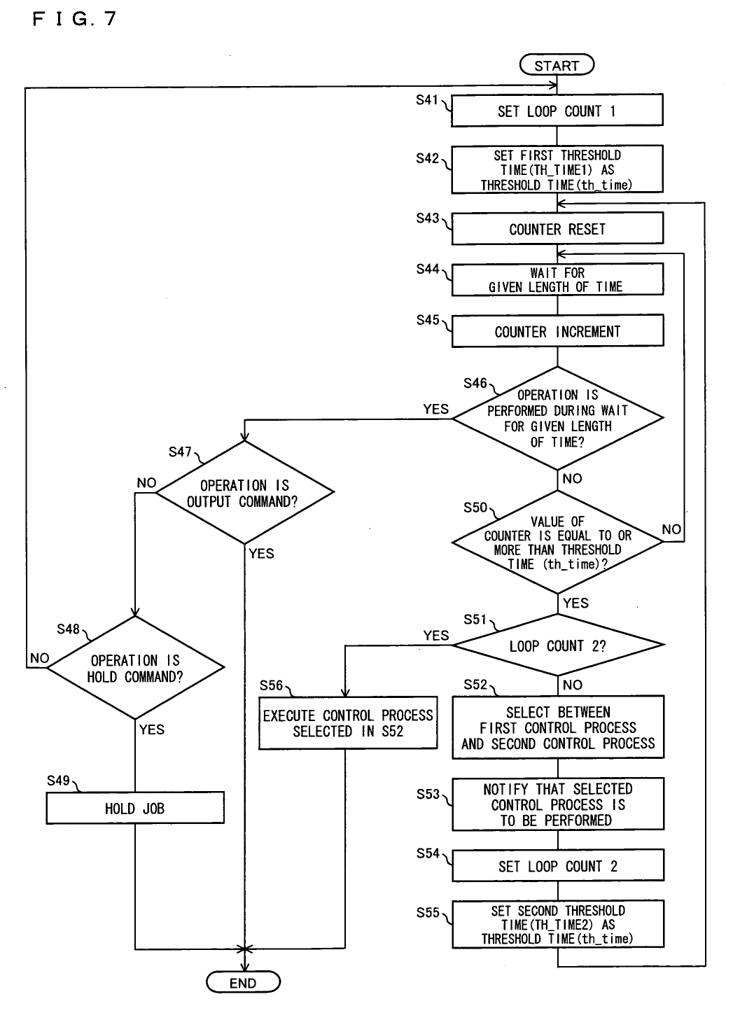

The following describes a process of the job controlling section 59c in the present embodiment more specifically, with reference to FIG. 7. FIG. 7 is a flowchart showing the flow of the process of the job controlling section 59c in Embodiment 3.

The following explains about FIG. 7 by taking, as an example, a process in the copy mode. In terms of this, a preview display of an image to be printed in the copy mode starts at START in FIG. 7. Further, in Embodiment 2, a hold command for holding a job can be inputted only after the image of (b) of FIG. 2 is displayed. In contrast, in the present embodiment, a hold command can be inputted from the operation panel 57 anytime during the preview display.

Step S41 through S46 in FIG. 7 are the same as the steps S1 through S6 in FIG. 3, respectively, and therefore are not explained here. Further, a first threshold time in S42 is 60 second, which is the same as the first threshold time in S2. A given length of time in S44 is 0.01 second, which is the same as the given length of time in S4. However, the first threshold time and the given length of time are not limited to these values.

In cases where a user operates the operation panel 57 and inputs an output command during standby in S44 in FIG. 7 (YES in S46 and YES in S47), the job controlling section 59c causes the printing section 53 to output (print) an image of a displayed preview, so as to complete a job. The preview display is terminated at the time of completion of the job.

Meanwhile, in cases where the user inputs a hold command from the operation panel 57 during the standby in S44 (YES in S46, NO in S47, and YES in S48), the job controlling section 59c causes a job of outputting (printing) an image of a displayed preview to enter the hold state (S49). At the time when the job has entered the hold state, the preview display for the job is terminated.

In cases where the user operates the operation panel 57 and performs other operation except for the input of an output command and the input of a hold command during the standby in S44 (YES in S46, NO in S47, and NO in S48), the process of the job controlling section 59c returns to S41.

On the other hand, in cases where no user operation is performed during the standby in S44 (NO in S46), the job controlling section 59c judges whether or not a value of a counter is equal to or more than a threshold time (S50). If the value of the counter is not equal to or more than the threshold time (NO in S50), the process of the job controlling section 59c returns to S44.

When the value of the counter becomes equal to or more than the threshold time (YES in S50) by repeatedly performing the steps S44 through S46, and S50, the job controlling section 59c judges whether or not a loop count 2 (output check state) is set (S51). When the process reaches to S51 for the first time, not the loop count 2 but a loop count 1 is set. Therefore, as shown in FIG. 7, the process of the job controlling section 59c proceeds to S52.

In S52, the job controlling section 59c selects between the first control process and the second control process according to a content of a job corresponding to a preview displayed on the display section 57a, by referring to the condition/process table of FIG. 6.

The first control process: a process of causing the multifunction printer 50 to execute a job corresponding to a preview displayed on the display section 57a.
The second control process: a process of causing a job corresponding to a preview displayed on the display section 57a to enter the hold state.

After S52, the job controlling section 59c gives an instruction to the notification section 59d so that the notification section 59d that has received the instruction notifies the user that a control process selected in S52 is to be performed later (S53). More specifically, in cases where the first control process is selected in S52, the notification section 59d causes the display section 57a to display the image of (a) of FIG. 2 thereon so that the user is notified that printing is to be performed later. Further, in cases where the second control process is selected in S52, the notification section 59d causes the display section 57a to display the image of (b) of FIG. 2 thereon so that the user is notified that the job is to enter the hold state later.

Further, a remaining time to be shown in the image of (a) or (b) of FIG. 2 is a second threshold time to be set in the after-mentioned step S55. The second threshold time is 10 seconds, which is the same as in Embodiments 1 and 2. It should be noted that the second threshold time is not limited to 10 seconds and may be altered.

After S53, the job controlling section 59c cancels the setting of the loop count 1 and sets the loop count 2 (S54). Further, the job controlling section 59c cancels the setting of the first threshold time and sets the second threshold time as the threshold time (S55). Then, the process of the job controlling section 59c returns to S43 in which the counter is reset. After that, the steps S44 through S50 are performed.

The steps S44 through S46, and S50 are repeatedly performed, and when the value of the counter becomes equal to or more than the threshold time (YES in S50), the job controlling section 50c judges whether or not the loop count 2 (output check state) is set (S51). When the process reaches S51 for the second time, the loop count 2 is set. Accordingly, as shown in FIG. 7, the process of the job controlling section 59c proceeds to S56.

In S56, the job controlling section 59c performs the control process selected in S52 and completes the process. At this time, the preview display is also terminated. That is, in S56, either execution of a job corresponding to the displayed preview or a process of causing the job corresponding to the displayed preview to enter the hold state is performed. In the example of FIG. 6, in cases where the job corresponding to the preview is color printing, the job is to enter the hold state in S56. Further, in cases where the job corresponding to the preview is monochrome printing and the number of pages to be printed is less than 10, the job is to be executed. Moreover, in cases where the job corresponding to the preview is monochrome printing and the number of pages to be printed is not less than 10, the job is to enter the hold state in S56.

In the above process of FIG. 7, in cases where a total time of the first threshold time and the second threshold time is taken as a predetermined time, if no user operation is performed to the multifunction printer 50 for the predetermined time while a preview is displayed, the job controlling section 59c performs either the first control process of causing the multifunction printer 50 to execute a job corresponding to the preview or the second control process of causing the job corresponding to the preview to enter the hold state (S56). On this account, even if the user does not perform any operation while a preview is displayed, when the predetermined time elapses, a job of outputting an image of the displayed preview is forcibly executed or the job forcibly enters the hold state. This allows another user, different from the user who inputted the job, to causes the multifunction printer 50 to execute another job (a subsequent job). This yields an effect that a decrease in efficiency of the multifunction printer 50 can be restrained.

Further, the job controlling section 59c selects between the first control process and the second control process as a control process suitable for a job corresponding to a displayed preview, by referring to the condition/process table shown in FIG. 6. That is, either the first control process or the second control process is performed according to a content of the job. For example, for a job of a facsimile transmission process, a transmission cost occurs. Therefore, it is highly necessary to confirm with the user whether the job is to be executed or not. In view of this, the second control process (hold) is suitable for the facsimile transmission process, as shown in FIG. 6. Further, for a job of color printing or printing of not less than a predetermined number of pages, the job costs much. Therefore, it is highly necessary to confirm with the user whether the job is to be executed or not. In view of this, the second control process is suitable for this job, as shown in FIG. 6. Moreover, for a job of image transmission of not less than a predetermined amount of data, it may cause a trouble for a destination that receives the data, because the amount of data is excessive. Therefore, it is necessary to confirm with the user whether the job is to be executed or not. In view of this, the second control process is suitable for this job. On the other hand, for a job of monochrome printing of a few pages, the first control process is suitable. This is because: (i) as it does not cost too much, there is not so much need to confirm with the user whether the job is to be executed or not; and (ii) it is necessary to restrain accumulation of hold jobs as much as possible.

According to the procedure of FIG. 7, in cases where the first control process is to be performed in S56, the notification section 59d notifies the user that a job corresponding to a displayed preview is to be executed. In cases where the second control process is to be performed in S56, the notification section 59d notifies the user that the job corresponding to the displayed preview is to enter the hold state (S53). This yield an effect that it is possible to retrain that a job is forcibly executed unexpectedly for the user, or a job forcibly enters the hold state unexpectedly for the user. For example, for a user who does not want to hold a job but wants to execute the job (output), by inputting an output command, it is possible to prevent the job from forcibly entering the hold state. Further, for a user who does not want to execute a job (output) but wants to hold the job, by inputting a hold command, it is possible to prevent the job (output) from being forcibly executed. Further, if the user inputs any other operation (NO in S48), it is possible to continue the preview display.

Further, in the present embodiment, the notification section 59d may not perform notification especially. In this case, the process is set to proceed to not S53 but S54 after S52, in FIG. 7.

Although not shown in FIG. 7, the steps S35 and S36 in FIG. 5 may be performed after the step S49 is performed or after the second control process is performed in S56. In this case, it is possible to send, to the user, an e-mail that notifies that a job has entered the hold state, when the job has entered the hold state. Moreover, after the first control process is performed (a job is forcibly executed) in S56, or in cases of YES in S47, it may be also possible to read out, from the storage device 54, a mail address of a user of the job having been executed, and then to send to the mail address an e-mail notifying that the job has been executed. That is, the present embodiment may be arranged such that: user authentication is performed in the same manner as in Embodiment 2; and after S49, after S56, or in the case of YES in S47 in FIG. 7, a mail processing section reads out a mail address from the storage device 54 in the same manner as in Embodiment 2 and sends such an e-mail to the mail address.

Similarly to FIG. 3 or FIG. 5, the process in FIG. 7 is also applicable to an output process (printing) in the facsimile reception mode, an output process (transmission) in the facsimile transmission mode, and an output process (transmission) in the image transmission mode.

Further, Embodiment 3 is such that either the first control process or the second control process is selected according to a content of a job. However, Embodiment 3 is not limited to such an embodiment.

For example, the job controlling section 59c may be arranged as follows. The job controlling section 59c may judge, in S52, whether or not a total data amount, which is a total amount of data of all jobs in the hold state, is equal to or more than a predetermine amount (for example, 16 GB). If the total data mount is equal to or more than the predetermined amount, the job controlling section 59c may select the first control process. If the total data amount is less than the determined amount, the job controlling section 59c may select the second control process. With the arrangement, it is possible to restrain that a resource of a computer is consumed vainly due to excessive accumulation of hold jobs. Since data of a job in the hold state is stored in the storage device 54, it is possible for the job controlling section 59c to detect the total data amount by accessing the storage device 54.

Further, the job controlling section 59c may be arranged as follows. The job controlling section 59c may judge, in S52, whether or not the number of hold jobs (jobs in the hold state) stored in the storage device 54 is equal to or more than a predetermined number (for example, 16). If the number of hold jobs is equal to or more than the predetermined number, the job controlling section 59c may select the first control process. If the number of hold jobs is less than the predetermined number, the job controlling section 59c may select the second control process. The arrangement yields an effect that it is possible to restrain that the number of hold jobs becomes excessive and to restrain expense in time and effort for the user to search for an intended hold job. That is, there are some cases where in searching for an intended hold job, the user operates a multifunction printer (the image output apparatus) to display a list of hold jobs and looks through the list with eyes to find the intended hold job. In such a case, if the number of hold jobs is excessive, it will take much expense in time and effort for the search. For this reason, it is not preferable that the number of hold jobs becomes excessive.

In cases where the above multifunction printer 50 performs only an embodiment (for example, FIG. 3) that does not require user authentication, the reading/writing section 58 and the authenticating section 59 may not be provided particularly. Further, the above multifunction printer 50 is arranged such that a user ID is inputted from the reading/writing section 58. However, a user ID may be inputted from a keyboard of the operation panel 57.

Further, it is also possible to realize Embodiment 1 through 3 by recording in a storage medium a program for causing a computer to function as each section in the control apparatus 59 according to any one of Embodiment 1 through 3 and by causing the computer, which controls the multifunction printer 50, to read the program. The storage medium is a computer-readable storage medium containing control program code (executable program, intermediate code program, or source program) to be executed by a computer, and a portable removable storage medium. It should be noted that the storage medium may be a memory (not shown) for processing in a microcomputer, for example, the storage medium may be a program medium such as a ROM per se. Alternatively, a program reading device that is provided as a program medium may be provided as an external storage device (not shown), and the storage medium may be read by being inserted into the program reading device.

In either case, the contained program code may be arranged to be accessible to a microprocessor that will execute the program code. Alternatively, the program code may be arranged to be read and then downloaded to a program storage area (not shown) of the microcomputer. It is assumed that the download program is stored in advance in the main apparatus.

It should be noted here that the storage medium is a storage medium arranged to be separable from the main body. The storage medium may be, for example, a tape, such as a magnetic tape or a cassette tape; a disk encompassing a magnetic disk, such as a flexible disk or a hard disk, and an optical disk, such as CD-ROM/MO/MD/DVD; a card, such as an IC card (memory card) or an optical card; or a semiconductor memory, such as a mask ROM/EPROM (erasable programmable read-only memory)/EEPROM (electrically erasable programmable read-only memory)/flash ROM. All these storage media hold a program code in a fixed manner.

Alternatively, in a case of a system configuration connectable to communication networks including the Internet, the program medium may be a medium carrying the program code in a flowing manner as in the downloading of a program code over a communication network. Further, when the program code is downloaded over a communications network in this manner, the download program may be stored in advance in the main apparatus or installed from another storage medium. The present embodiment can be realized in the form of a computer data signal, embedded in a carrier wave, in which the program code is embodied electronically. The storage medium is read by a digital color multifunction printer/copying machine or a program reading device provided in a computer system, whereby the aforementioned process of the control apparatus 59 is executed.

As described above, a control apparatus of the present embodiment is a control apparatus (i) which controls an image output apparatus that executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, and the control apparatus of the present embodiment includes a job controlling section which selects a control process from a first control process of causing the image output apparatus to execute a job corresponding to a preview displayed on the display section and a second control process of causing the job corresponding to the preview displayed on the display section to enter the hold state, and which performs the selected control process when no operation is performed to the image output apparatus for a predetermined time while the preview is being displayed. Further, a control method, according to the present embodiment, of an image output apparatus is a method performed by a control apparatus (i) which controls an image output apparatus that executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, and the method of the present embodiment includes the steps of: selecting, by the control apparatus, a control process from a first control process of causing the image output apparatus to execute a job corresponding to a preview displayed on the display section and a second control process of causing the job corresponding to the preview displayed on the display section to enter the hold state; and performing, by the control apparatus, the selected control process when no operation is performed to the image output apparatus for a predetermined time while the preview is being displayed. In the above arrangement, even if a user does not perform any operation with a preview being displayed, when a predetermined time elapses, a job of outputting an image for the displayed preview is forcibly executed or forcibly enters the hold state. This allows another user, different from the user who inputted the job, to use the image output apparatus. This yields an effect that a decrease in efficiency of the image output apparatus can be restrained.

As described above, it is preferable that the job controlling section select a control process suitable for a content of the job corresponding to the preview by referring to a storage section in which content information indicative of a content of a job and process information indicative of either the first control process or the second control process, which is suitable for the content of the job, are stored in advance in association with each other. This yield an effect that either the first control process or the second control process, which is suitable for a content of a job corresponding to the preview, is performed. For example, a job of color printing costs much. In view of this, it is preferable to confirm execution of the job with a user, before the job is executed, and therefore the second control process is suitable. On the other hand, for a job of monochrome printing of a few pages, since it does not take much cost and it is necessary to restrain accumulation of hold jobs as much as possible, the first control process is suitable.

As described above, the job controlling section may select the first control process when a total data amount, which is a data amount of all jobs in the hold state, is not less than a predetermined amount, and the job controlling section may select the second control process when the total data amount is less than the predetermined amount. With the arrangement, it is possible to restrain that a resource of a computer is consumed vainly due to excessive accumulation of hold jobs.

As described above, the job controlling section may select the first control process when the number of hold jobs, which is the number of jobs in the hold state, is not less than a predetermined number, and the job controlling section may select the second control process when the number of hold jobs is less than the predetermined number. This arrangement makes it advantageously possible to restrain that the number of hold jobs becomes excessive and to restrain expense in time and effort for a user to search for an intended hold job. That is, there may occur such cases where in searching for an intended hold job, the user operates an image output apparatus to display a list of hold jobs and looks through the list with eyes to find the intended hold job. In such cases, if the number of hold jobs is excessive, it will take much expense in time and effort for the search. Therefore, it is not preferable that the number of hold jobs becomes excessive.

As described above, it is preferable that the control apparatus include a notification section which, in a case where the first control process is selected, notifies a user that the job corresponding to the preview displayed on the display section is to be executed, and which, in a case where the second control process is selected, notifies the user that the job corresponding to the preview displayed on the display section is to enter the hold state, and that the notification section perform the notification when no operation is performed to the image output apparatus for a threshold time, which is shorter than the predetermined time, while the preview is being displayed. This arrangement makes it advantageously possible to restrain that the job is executed unexpectedly for the user and to restrain that the job enters the hold state unexpectedly for the user.

As described above, a control apparatus of Embodiment 1 is a control apparatus which controls an image output apparatus that executes a job of outputting an image and a process of displaying a preview of the image on a display section before the job is executed, and the control apparatus of Embodiment 1 includes a job controlling section which causes the image output apparatus to execute a job corresponding to a displayed preview when no operation is performed to the image output apparatus for a predetermined time while the preview is being displayed. Further, a control method, according to Embodiment 1, of an image output apparatus is a method performed by a control apparatus which controls an image output apparatus that executes a job of outputting an image and a process of displaying a preview of the image on a display section before the job is executed, and the method of Embodiment 1 includes the step of causing, by the control apparatus, the image output apparatus to execute a job corresponding to a displayed preview when no operation is performed to the image output apparatus for a predetermined time while the preview is being displayed. In the arrangement, even if the user does not perform any operation to the image output apparatus with a preview being displayed, when a predetermined time elapses, the job corresponding to the displayed preview is forcibly executed. Accordingly, the arrangement allows another user, different from the user who inputted the job, to use the image output apparatus. This yields an effect that a decrease in efficiency of the image output apparatus can be restrained.

As described above, it is preferable that the control apparatus include a notification section which notifies a user that the job corresponding to the preview displayed on the display section is to be executed, and the notification section perform the notification when no operation is performed to the image output apparatus for a threshold time, which is shorter than the predetermined time, while the preview is being displayed. In the above arrangement, the user is notified as such that the job is to be executed forcibly. The arrangement makes it possible to restrain that the job is forcibly executed unexpectedly for the user. Therefore, for the user who does not want execution of the job or the use who wants to continue to check a preview, if he/she inputs a necessary command, it is possible to prevent the job from being executed abruptly.

As described above, a control apparatus of Embodiment 2 is a control apparatus (i) which controls an image output apparatus that executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, and the control apparatus of Embodiment 2 includes a job controlling section which causes a job corresponding to a preview displayed on the display section to enter the hold state when no operation is performed to the image output apparatus for a predetermined time while the preview is being displayed. Further, a control method, according to Embodiment 2, of an image output apparatus is a method performed by a control apparatus (i) which controls an image output apparatus that executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, and the method of Embodiment 2 includes the step of: causing, by the control apparatus, a job corresponding to a preview displayed on the display section to enter the hold state when no operation is performed to the image output apparatus for a predetermined time while the preview is being displayed. In the arrangement, even if the user does not perform any operation to the image output apparatus while a preview is being displayed, when a predetermined time elapses, a job corresponding to the displayed preview forcibly enters the hold state. This allows another user, different from the user who inputted the job, to use the image output apparatus. This yields an effect that a decrease in efficiency of the image output apparatus can be restrained.

As described above, it is preferable that the control apparatus further include a notification section which notifies a user that the job corresponding to the preview displayed on the display section is to enter the hold state, and the notification section perform the notification when no operation is performed to the image output apparatus for a threshold time, which is shorter than the predetermined time, while the preview is being displayed. In the arrangement, the user is notified as such that the job is to forcibly enter the hold state. This makes it possible to restrain that the job enters the hold state unexpectedly for the user. For the user who does not want to hold the job, but wants to perform outputting, if he/she inputs an output command, it is possible to prevent the job from entering the hold state abruptly.

Further, it is preferable that the job be any one of a printing process of the image, a transmission process of the image, and a conversion process of converting the image into a predetermined file format. Further, an image output apparatus which includes the control apparatus and which is controlled by the control apparatus is also included in the scope of the present invention. Furthermore, the control apparatus may be realized by a computer. In this case, a program which causes the computer to function as the job controlling section and a computer-readable storage medium in which the program is stored are also included in the scope of the present invention.

The present invention is not limited to the description of the embodiments above, but may be altered by a skilled person within the scope of the claims. An embodiment based on a proper combination of technical means disclosed in different embodiments is encompassed in the technical scope of the present invention.

There are various multifunction printers capable of displaying a preview of an image to be processed in a job. A multifunction printer described as follows in Reference Example also can display a preview of an image to be processed in the job. In Reference Example, the multifunction printer is referred to as an image forming apparatus.

In order to achieve the above object, a control apparatus of the present invention is a control apparatus (i) which controls an image output apparatus that executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, and the control apparatus of the present invention includes a job controlling section which selects a control process from a first control process of causing the image output apparatus to execute a job corresponding to a preview displayed on the display section and a second control process of causing the job corresponding to the preview displayed on the display section to enter the hold state, and which performs the selected control process when no operation is performed to the image output apparatus for a predetermined time while the preview is being displayed. In the arrangement of the present invention, even if the user does not perform any operation with a preview being displayed, when a predetermined time elapses, a job of outputting an image of the displayed preview is forcibly executed or forcibly enters the hold state. Accordingly, this allows another user, different from the user who inputted the job, to use the image output apparatus. This yields an effect that a decrease in efficiency of the image output apparatus can be restrained.

Further, in the control apparatus of the present invention, it is preferable that the job controlling section select a control process suitable for a content of the job corresponding to the preview by referring to a storage section in which content information indicative of a content of a job and process information indicative of either the first control process or the second control process, which is suitable for the content of the job, are stored in advance in association with each other. This yield an effect that either the first control process or the second control process, which is suitable for content of a job corresponding to the preview, is performed. For example, a job of color printing costs much. In view of this, it is preferable to confirm execution of the job with a user, before the job is executed, and therefore the second control process is suitable. On the other hand, for a job of monochrome printing of a few pages, since it does not take much cost and it is necessary to restrain accumulation of hold jobs as much as possible, the first control process is suitable.

Further, in the control apparatus of the present invention, the job controlling section may select the first control process when a total data amount, which is a data amount of all jobs in the hold state, is not less than a predetermined amount, and the job controlling section may select the second control process when the total data amount is less than the predetermined amount. With the arrangement, it is possible to restrain that a resource of a computer is consumed vainly due to excessive accumulation of hold jobs.

Further, in the control apparatus of the present invention, the job controlling section may select the first control process when the number of hold jobs, which is the number of jobs in the hold state, is not less than a predetermined number, and the job controlling section may select the second control process when the number of hold jobs is less than the predetermined number. This arrangement makes it advantageously possible to restrain that the number of hold jobs becomes excessive and to restrain expense in time and effort for a user to search for an intended hold job. That is, there may occur such cases where in searching for an intended hold job, the user operates an image output apparatus to display a list of hold jobs and looks through the list with eyes to find the intended hold job. In such cases, if the number of hold jobs is excessive, it will take much expense in time and effort for the search. Therefore, it is not preferable that the number of hold jobs becomes excessive.

Further, in addition to the above arrangement, it is preferable that the control apparatus of the present invention include a notification section which, in a case where the first control process is selected, notifies a user that the job corresponding to the preview displayed on the display section is to be executed, and which, in a case where the second control process is selected, notifies the user that the job corresponding to the preview displayed on the display section is to enter the hold state, and that the notification section perform the notification when no operation is performed to the image output apparatus for a threshold time, which is shorter than the predetermined time, while the preview is being displayed. This arrangement makes it advantageously possible to restrain that the job is executed unexpectedly for the user and to restrain that the job enters the hold state unexpectedly for the user.

In order to achieve the above object, a control apparatus of the present invention is a control apparatus which controls an image output apparatus that executes a job of outputting an image and a process of displaying a preview of the image on a display section before the job is executed, and the control apparatus of the present invention includes a job controlling section which causes the image output apparatus to execute a job corresponding to a displayed preview when no operation is performed to the image output apparatus for a predetermined time while the preview is being displayed. In the arrangement of the present invention, even if the user does not perform any operation to the image output apparatus with a preview being displayed, when a predetermined time elapses, the job corresponding to the displayed preview is forcibly executed. Accordingly, the arrangement allows another user, different from the user who inputted the job, to use the image output apparatus. This yields an effect that a decrease in efficiency of the image output apparatus can be restrained.

Furthermore, in addition to the above arrangement, it is preferable that the control apparatus of the present invention include a notification section which notifies a user that the job corresponding to the preview displayed on the display section is to be executed, and the notification section perform the notification when no operation is performed to the image output apparatus for a threshold time, which is shorter than the predetermined time, while the preview is being displayed. In the above arrangement, the user is notified as such that the job is to be executed forcibly. The arrangement makes it possible to restrain that the job is forcibly executed unexpectedly for the user. Therefore, for the user who does not want execution of the job or the user who wants to continue to check a preview, if he/she inputs a necessary command, it is possible to prevent the job from being executed abruptly.

In order to achieve the above object, a control apparatus of the present invention is a control apparatus (i) which controls an image output apparatus that executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, and the control apparatus of the present invention includes a job controlling section which causes a job corresponding to a preview displayed on the display section to enter the hold state when no operation is performed to the image output apparatus for a predetermined time while the preview is being displayed. In the arrangement, even if the user does not perform any operation to the image output apparatus while a preview is being displayed, when a predetermined time elapses, a job corresponding to the displayed preview forcibly enters the hold state. This allows another user, different from the user who inputted the job, to use the image output apparatus. This yields an effect that a decrease in efficiency of the image output apparatus can be restrained.

Furthermore, in addition to the above arrangement, it is preferable that the control apparatus of the present invention further include a notification section which notifies a user that the job corresponding to the preview displayed on the display section is to enter the hold state, and the notification section perform the notification when no operation is performed to the image output apparatus for a threshold time, which is shorter than the predetermined time, while the preview is being displayed. In the arrangement, the user is notified as such that the job is to forcibly enter the hold state. This makes it possible to restrain that the job enters the hold state unexpectedly for the user. For the user who does not want to hold the job but wants to perform outputting, if he/she inputs an output command, it is possible to prevent the job from entering the hold state abruptly.

Further, in the control apparatus of the present invention, it is preferable that the job be any one of a printing process of the image, a transmission process of the image, and a conversion process of converting the image into a predetermined file format.

Further, an image output apparatus which includes the control apparatus and which is controlled by the control apparatus and is also included in the scope of the present invention.

Moreover, a control method, according to the present invention, of an image output apparatus is a method performed by a control apparatus (i) which controls an image output apparatus that executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, and the method of the present invention includes the steps of: selecting, by the control apparatus, a control process from a first control process of causing the image output apparatus to execute a job corresponding to a preview displayed on the display section and a second control process of causing the job corresponding to the preview displayed on the display section to enter the hold state; and performing, by the control apparatus, the selected control process when no operation is performed to the image output apparatus for a predetermined time while the preview is being displayed.

Further, a control method, according to the present invention, of an image output apparatus is a method performed by a control apparatus which controls an image output apparatus that executes a job of outputting an image and a process of displaying a preview of the image on a display section before the job is executed, and the method of the present invention includes the step of causing, by the control apparatus, the image output apparatus to execute a job corresponding to a displayed preview when no operation is performed to the image output apparatus for a predetermined time while the preview is being displayed.

Further, a control method, according to the present invention, of an image output apparatus is a method performed by a control apparatus (i) which controls an image output apparatus that executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, and the method of the present invention includes the step of: causing, by the control apparatus, a job corresponding to a preview displayed on the display section to enter the hold state when no operation is performed to the image output apparatus for a predetermined time while the preview is being displayed.

Furthermore, the control apparatus may be realized by a computer. In this case, a program for causing the computer to function as the job control section, and a computer-readable storage medium in which the program is stored are also included in the scope of the present invention.

### Reference Example

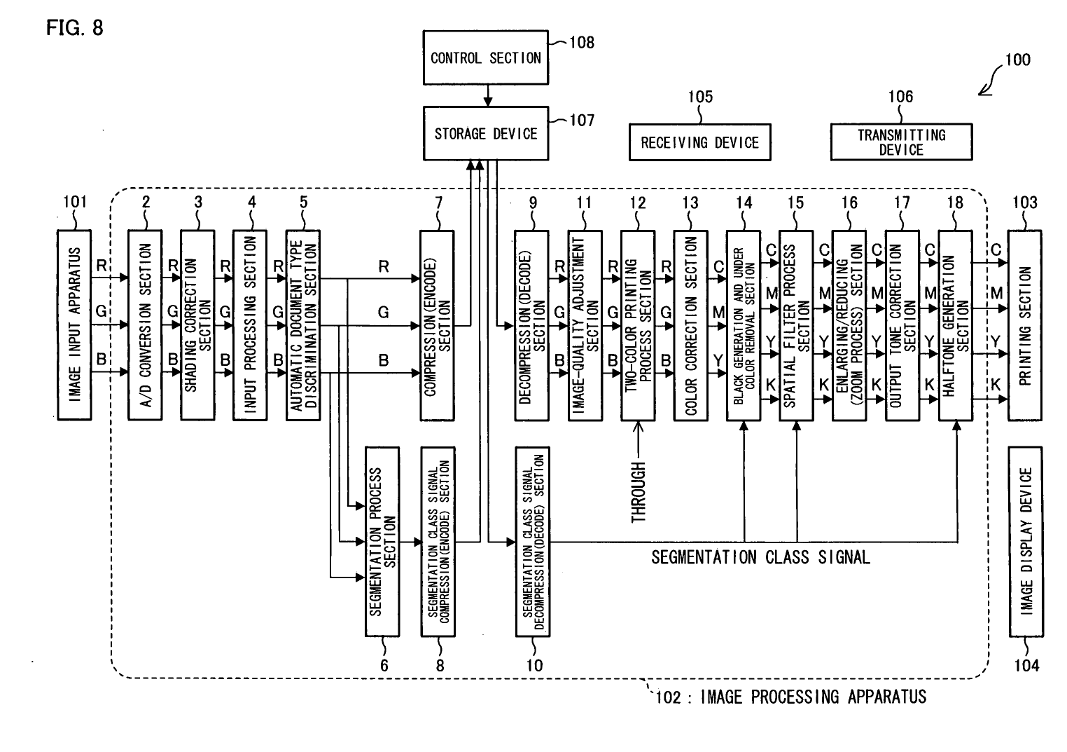

The following describes a reference example with reference to attached drawings. FIG. 8 is a block diagram schematically showing an arrangement of an image forming apparatus 100 of the reference example.

The image forming apparatus 100 is a digital color multifunction printer that executes a mode selected from among a copy mode, a print mode, a facsimile transmission mode, a facsimile reception mode, and an image transmission mode.

The copy mode means a mode in which to read image data (generates image data by scanning (reading) a document) and print an image of the image data onto a sheet of paper. The print mode means a mode in which to print, onto a sheet of paper, an image of image data sent from a terminal apparatus connected to the image forming apparatus. The facsimile transmission mode means: a normal facsimile mode in which to transmit, to an external apparatus via a telephone line, image data obtained by scanning a document; and an Internet facsimile mode in which to transmit an e-mail with the image data attached thereto. The facsimile reception mode means a mode in which to receive image data from an external apparatus by facsimile and print an image of the received image data onto a sheet of paper. The image transmission mode means: (1) a mode (scan to e-mail mode) in which to attach, to an e-mail, image data generated by scanning a document, and transmit the e-mail to a specified address; (2) a mode (scan to ftp mode) in which to transmit, to a folder specified by a user, image data generated by scanning a document; and (3) a mode (scan to usb mode) in which to transmit, to a USB memory mounted in the image forming apparatus 100, image data generated by scanning a document. It should be noted that, in the present reference example, the facsimile transmission mode and the image transmission mode are each classified as above according to the type of image processing operation.

Further, in the copy mode or print mode, the user can select a black-and-white mode in which to output a black-and-white image, a full-color mode in which to output a full-color mage, a single-color mode in which to output a monochrome image having only one color desired by the user, or a two-color mode in which to output a two-color image having black and one color desired by the user.

For example, in cases where the user selects the single-color mode in the copy mode or print mode, the monochromatic image is printed. Further, in cases where the user selects the two-color mode in the copy mode or print mode, the two-color image is printed. It should be noted that in the single-color mode or two-color mode, the user selects his/her desired color from among R (red), G (green), B (blue), C (cyan), M (magenta), and Y (yellow).

Further, in the present reference example, it is possible to set an automatic discrimination mode in the copy mode. In the automatic discrimination mode, the image forming apparatus 100 performs auto color selection (ACS) for judging whether an object to be copied is a color document or a black-and-white document. In the case of a color document, the image forming apparatus 100 performs an output process in the full-color mode. In the case of a black-and-white document, the image forming apparatus 100 performs an output process in the black-and-white mode.

As shown in FIG. 8, the image forming apparatus 100 includes an image input apparatus 101, an image processing apparatus 102, a printing section 103, an image display device 104, a receiving device 105, a transmitting device 106, a storage device 107, and a control section 108.

The image input apparatus 101 is image scanning means for generating image data by scanning a document in the copy mode, the facsimile transmission mode, and the image transmission mode. More specifically, the image input apparatus 101, which includes a scanner section having a CCD (charge-coupled device), converts light reflected by a document into an electrical signal separated into colors RGB (i.e., into an analog image signal) and sends the electrical signal to the image processing apparatus 102.

It should be noted that the image input apparatus 101 scans a document image in full color in any one of the full-color mode, the single-color mode, and the two-color mode. Further, the image input apparatus 101 scans a document image in full color even in cases where the image processing apparatus 102 performs the aforementioned auto color selection.

The image processing apparatus 102 is an integrated circuit, constituted by an ASIC (application specific integrated circuit), which performs image processing on image data (image signals). As shown in FIG. 8, the image processing apparatus 102 includes the following blocks: an A/D (analog/digital) conversion section 2, a shading correction section 3, an input processing section 4, an automatic document type discrimination section 5, a segmentation process section 6, a compression (encode) section 7, a segmentation class signal compression (encode) section 8, a decompression (decode) section 9, a segmentation class signal decompression (decode) section 10, an image-quality adjustment section 11, a two-color printing process section 12, a color correction section 13, a black generation and under color removal section 14, a spatial filter section 15, an enlarging/reducing (zoom process) section 16, an output tone correction section 17, and a halftone generation section 18. Processes that are performed by the blocks of the image processing apparatus 102 will be detailed later.

In the copy mode, facsimile transmission mode, or image transmission mode, the image processing apparatus 102 performs image processing on image data sent from the image input apparatus 101. In the print mode, the image processing apparatus 102 performs image processing on image data transmitted from a terminal apparatus. In the facsimile reception mode, the image processing apparatus 102 performs image processing on image data received from an external apparatus. Then, in the copy mode, print mode, or facsimile reception mode, the image processing apparatus 102 transmits, to the printing section 103, the image data subjected to image processing. In the facsimile transmission mode, the image processing apparatus 102 transmits, to the transmitting device 106, the image data subjected to image processing. Further, in the scan to e-mail mode, which is an image transmission mode, the image processing apparatus 102 transmits, to a mail processing section (not shown), the image data subjected to image processing. In the scan to ftp mode, which is another image transmission mode, the image processing apparatus 102 transmits, to a predetermined folder, the image data subjected to image processing. In the scan to usb mode, which is the other image transmission mode, the image processing apparatus 102 transmits, to a predetermined USB memory, the image data subjected to image processing.

The printing section (printer) 103 forms, onto a recording medium (e.g., a sheet of paper), an image of image data sent from the image processing apparatus 102. An example is an electrophotographic or ink-jet color printer. The term “printing” in the present reference example means printing in the print mode, printing in the copy mode, or printing in the facsimile reception mode.

The image display device 104 is a liquid crystal display provided in an operation panel (not shown) of the image forming apparatus 100, and is display means capable of displaying a color image. Further, the image display device 104, covered with a touch panel, functions as an input interface of the image forming apparatus 100. That is, the image display device 104 displays a GUI (graphical user interface) for inputting various commands to the image forming apparatus 100 and an operation guide.

Further, before execution of printing in the copy mode or facsimile reception mode, the image forming apparatus 100 of the present reference example can display, on the image display device 104, a preview of an image to be printed. Furthermore, before execution of transmission in the facsimile transmission mode or image transmission mode, the image forming apparatus 100 of the present reference example can display, on the image display device 104, a preview of an image to be transmitted.

Further, in the copy mode or image transmission mode and the full-color mode, the image display device 104 displays a preview of a full-color image. In the copy mode or image transmission mode and the single-color mode, the image display device 104 displays a preview of a monochrome image. In the copy mode or image transmission mode and the two-color mode, the image display device 104 displays a preview of a two-color image.

The image display device 104 is not limited to the liquid crystal display, and may be display means other than the liquid crystal display (e.g., an organic EL display or a plasma display).

The receiving device 105 is a device, connected to a telephone line or the Internet, which receives image data from an external apparatus by facsimile communication. Further, the transmitting device 106 is a device, connected to a telephone line or the Internet, which transmits, to an external apparatus by facsimile communication, image data inputted to the image input apparatus 101.

The storage device 107 is a hard disk in which image data to be processed in the image processing apparatus 102 is temporarily stored.

The control section 108 is a computer including a processor such as a CPU (central processing unit) or a DSP (digital signal processor), and comprehensively controls various types of hardware provided in the image forming apparatus 100. Further, the control section 108 functions to control data transfer between pieces of hardware provided in the image forming apparatus 100.

The following details the processes that are executed by the blocks of the image processing apparatus 102 in the copy mode, the facsimile transmission mode, the facsimile reception mode, and the image transmission mode, respectively. It should be noted that the image processing apparatus 102 of the present reference example has a block that operates while a mode a is being used but does not operate while a mode b different from the mode a is being used (the mode a and the mode b each being any one of the copy mode, the facsimile transmission mode, the facsimile reception mode, and the image transmission mode). Further, the image processing apparatus 102 has a block that varies in processing according to the mode being used. Furthermore, the image processing apparatus 102 has: a block that, even in the same mode, operates in processing of image data to be printed (transmitted) but does not operate in processing of image data to be previewed; and a block that, even in the same mode, varies between processing of image data to be printed (transmitted) and processing of image data to be previewed. In the following, therefore, the processes that are executed by the blocks of the image processing apparatus 102 are described according to the type of mode, and those processes which are executed in a printing process (or in a transmission process) and those processes which are executed at the time of a preview display are described separately.

(1) Copy Mode

(1-1) Printing Process

In the following, the image processing apparatus 102 is described with reference to FIG. 8, which shows the flow of image data in the image processing apparatus 102 performing a printing process in the copy mode and the full-color mode.

The A/D (analog/digital) conversion section 2 is a block that receives color image signals (RGB analog signals) from the image input apparatus 101 and converts the color image signals into digital image data (RGB digital signals). The shading correction section 3 is a block that receives image data form the A/D conversion section 2 and subjects the image data to a process of removing various distortions generated in illuminating, image-focusing, and image-sensing systems of the image input apparatus 101. The input processing section 4 is a block that receives RGB image data from the shading correction section 3 and subjects each of the RGB image data to a tone conversion process such as a gamma correction process.

In accordance with RGB image data (RGB density signals) subjected to processing such as gamma correction in the input processing section 4, the automatic document type discrimination section 5 discriminates among types of documents scanned by the image input apparatus 101. It should be noted here that the types of documents among which the automatic document type discrimination section 5 discriminates are a text document, a printed-picture document, a text/printed-picture document containing a text and a printed picture together, and the like. Further, in accordance with the image data, the automatic document type discrimination section 5 can perform auto color selection (ACS) for judging whether a scanned document is a color document or a black-and-white document and a process for judging whether or not a scanned document is a blank document (a solid-color document). It should be noted that the automatic document type discrimination section 5 sends the RGB image data to the segmentation process section 6 and the compression section 7.

In accordance with the RGB image data sent from the automatic document type discrimination section 5, the segmentation process section 6 performs a process of judging, for each pixel of the input image, what image area the pixel is classified into and generating a segmentation class signal indicating a result of the judgment. It should be noted here that the types of image areas among which the segmentation process section 6 discriminates are a black text area, a color text area, a halftone dot area, and the like. The segmentation process may take the form of a process of judging, for each block of pixels, what image area the block is classified into, instead of taking the form of a process of judging, for each pixel, what image area the pixel is classified into.

The compression section 7 is a block that performs a process of encoding image data (RGB signals) sent from the automatic document type discrimination section 5. The encoding is performed, for example, based on JPEG (Joint Photographic Experts Group).

The segmentation class signal compression section 8 is a block that performs a compression (encode) process on a segmentation class signal generated for each pixel. The compression process in the segmentation class signal compression section 8 is performed, for example, based on MMR (Modified Modified Read) or MR (Modified Read), which is a lossless compression technology.

The control section 108 receives encoded codes (encoded image data) from the compression section 7 and segmentation class signal codes (encoded segmentation class signals) from the segmentation class signal compression section 8, stores them temporarily in the storage device 107, and manages them as filing data. Then, in response to an instruction for a copy output operation, the control section 108 reads out, from the storage device 107, an encoded code and a segmentation class signal code corresponding to the encoded code, and sends them to the decompression section 9 and the segmentation class signal decompression section 10, respectively.

The control section 108 writes the storage address or data name of the encoded code and the storage address of the segmentation class signal code in a management table in association with each other. That is, the control section 108 controls reading or writing of encoded codes and segmentation class signal codes with reference to the management table.

The decompression section 9 decompresses the encoded code into RGB image data by performing a decompression (decode) process on the encoded code. Further, the segmentation class signal decompression section 10 performs a decompression process on the segmentation class signal code. The resulting segmentation class signal is sent to the black generation and under color removal section 14, the spatial filter section 15, and the halftone generation section 18. Then, the black generation and under color removal section 14, the spatial filter section 15, and the halftone generation section 18 select image processing according to the type of image area.

The image-quality adjustment section 11 receives the RGB image data from the decompression section 9, and performs background removal correction on the RGB image data by detecting a background in the RGB image data. Furthermore, the image-quality adjustment section 11 adjusts RGB balance (color adjustment of red, green, or blue), brightness, and intensity (saturation) in accordance with configuration information inputted by the user from the operation panel (not shown).

Furthermore, in the single-color mode, the image-quality adjustment section 11 converts the RGB image data into CMY image data complementary to the RGB image data. It should be noted here that the conversion of the RGB data into the CMY image data in the single-color mode is executed by using Eq. (1) below, where the coefficients r1 to r3 are defined based on [Table 1]. For example, in cases where the user selects cyan as his/her desired color in the single-color mode, the values of r1 to r3 in the column “Cyan” are referred to, with the result that r1=1, r2=0, and r3=0 are selected.

$$( \begin{matrix}C \\ M \\ Y\end{matrix} ) = ( \begin{matrix}r 1 \cdot a 1 & r 1 \cdot a 2 & r 1 \cdot a 3 \\ r 2 \cdot a 1 & r 2 \cdot a 2 & r 2 \cdot a 3 \\ r 3 \cdot a 1 & r 3 \cdot a 2 & r 3 \cdot a 3\end{matrix} ) \times ( \begin{matrix}R \\ G \\ B\end{matrix} ) + ( \begin{matrix}r 1 \cdot c \\ r 2 \cdot c \\ r 3 \cdot c\end{matrix} ) \\ a 1 = - 0.23046875 \\ a 2 = - 0.79296875 \\ a 3 = 0.0234375 \\ c = 255 \qquad Eq . ( 1 )$$

TABLE 1

| Adjustment | Output Color (Single Color) | | | | | |
|---|---|---|---|---|---|---|
| Plane | Red | Green | Blue | Cyan | Magenta | Yellow |
| r1 | 0 | 1 | 1 | 1 | 0 | 0 |
| r2 | 1 | 0 | 1 | 0 | 1 | 0 |
| r3 | 1 | 1 | 0 | 0 | 0 | 1 |

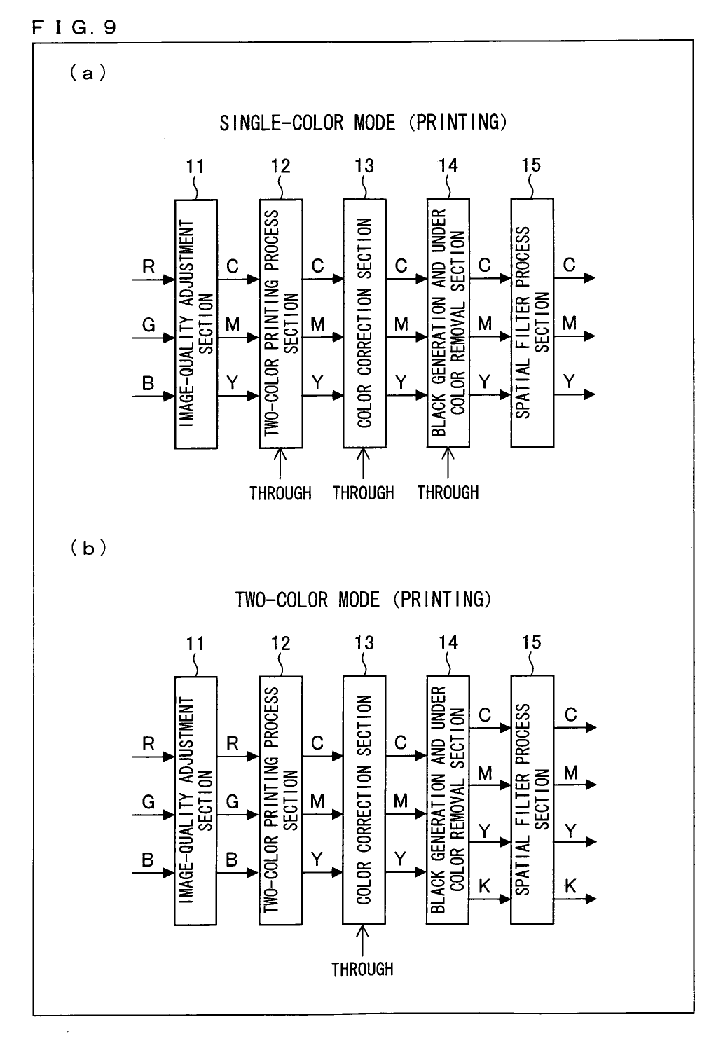

That is, whereas the output from the image-quality adjustment section 11 in the full-color mode is RGB image data as shown in FIG. 8, the output from the image-quality adjustment section 11 in the single-color mode is CMY image data as shown in (a) of FIG. 9. It should be noted that the output from the image-quality adjustment section 11 in the two-color mode is RGB image data as shown in (b) of FIG. 9. (a) of FIG. 9 shows some of the blocks of the image processing apparatus 102 performing a printing process in the copy mode and the single-color mode, and (b) of FIG. 9 shows some of the blocks of the image processing apparatus 102 performing a printing process in the copy mode and the two-color mode.

Further, the adjustment of intensity by the image-quality adjustment section 11 can be realized by using the matrix of Eq. (1) after varying the values of r1 to r3 and a1 to a3 of the matrix. This makes it possible to use the same matrix and the same image processing circuit for the adjustment of intensity and the conversion of image data (from RGB into CMY) in the single-color mode. Therefore, in the present reference example, the adjustment of intensity and the conversion of image data in the single-color mode are performed by the same processing section (image-quality adjustment section 11).

The two-color printing process section 12 is a block that, in the two color mode, receives RGB image data from the image-quality adjustment section 11 and converts the RGB image into CMY image data as shown in (b) of FIG. 9. The conversion of the RGB image data into the CMY image data in the two-color mode can be realized, for example, by a technique of [Embodiment 1] or [Embodiment 2] described in Japanese Patent Application Publication, Tokukai, No. 2007-28336 A.

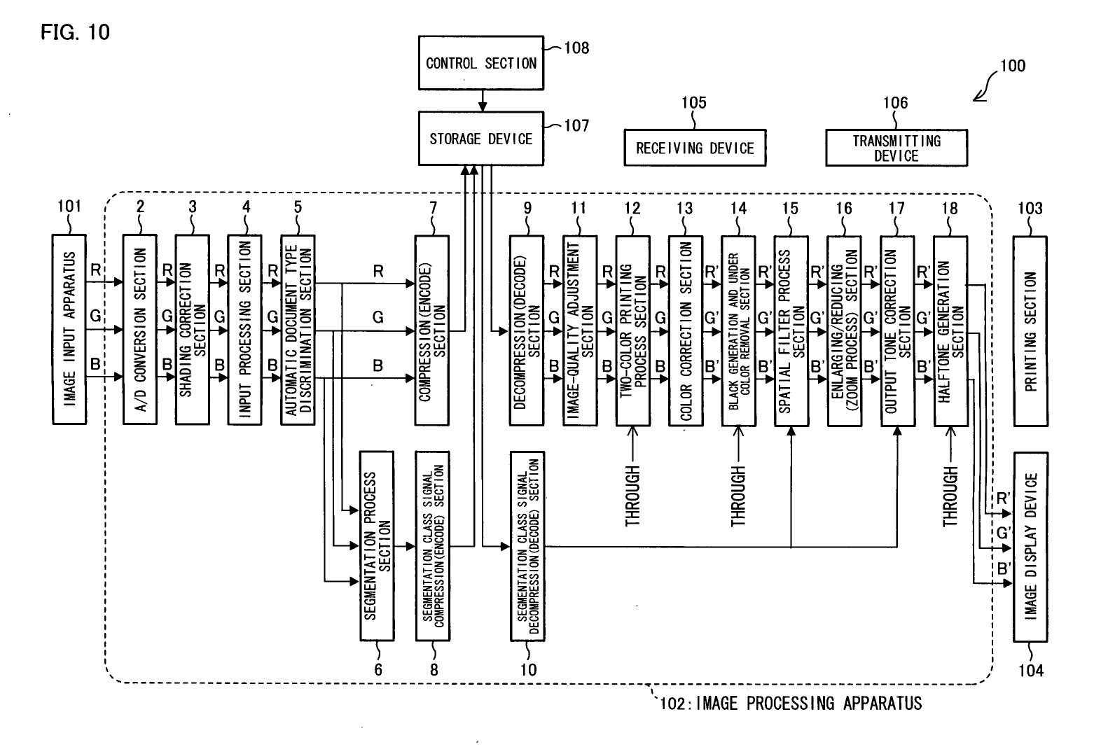

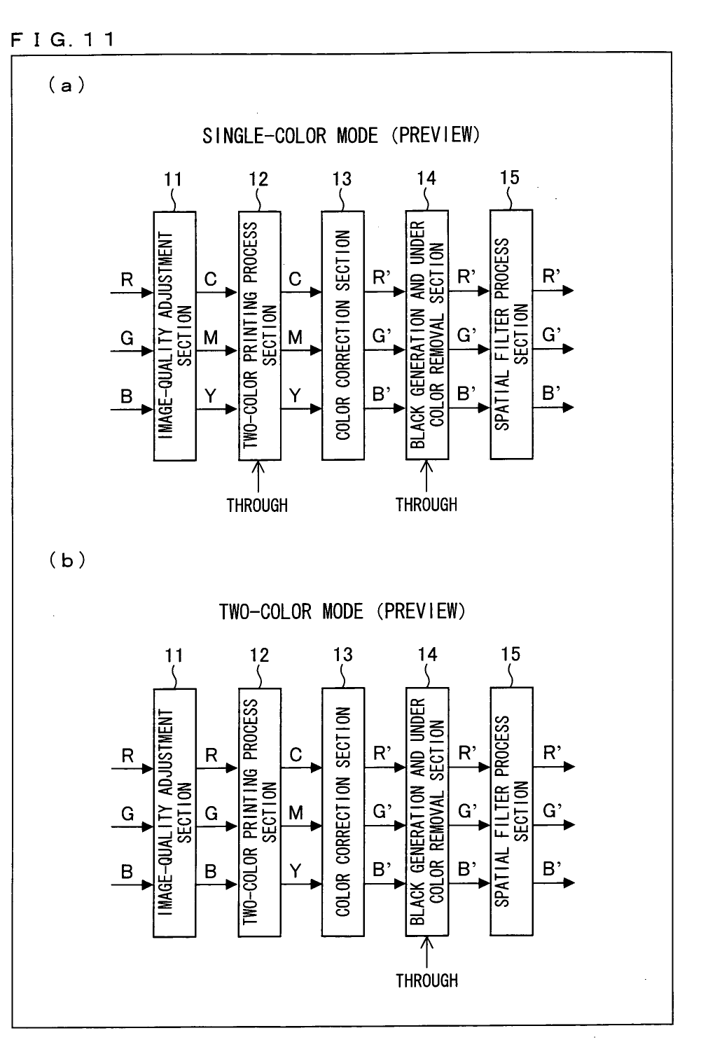

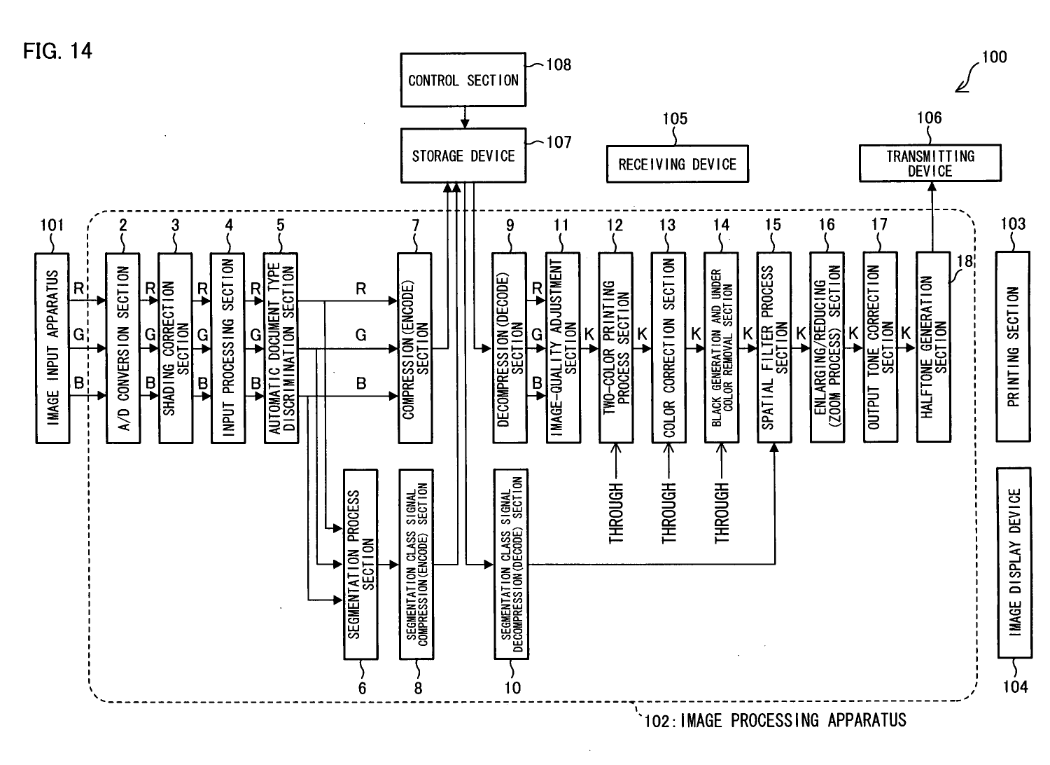

Further, in the full-color mode, as shown in FIG. 8, the two-color printing process section 12 performs no processing on the RGB image data sent from the image-quality adjustment section 11 and passes the image data directly on to the color correction section 13. That is, the term “through” in FIG. 8 indicates that an arrowed block performs no process on received data and passes the received data therethrough to its subsequent block. Further, the term “through” in FIG. 9, FIG. 10, FIG. 11, and FIG. 14 through FIG. 17 also has the same meaning as above. Furthermore, in the single-color mode, as shown in (a) of FIG. 9, the two-color printing process section 12 performs no processing on the CMY image data sent from the image-quality adjustment section 11 and passes the image data directly on to the color correction section 13.

The color correction section 13 is a block that, in the full-color mode, receives RGB image data from the two-color printing process section 12, performs a color correction process of converting the RGB image data into CMY image data, and performs a process of improving the color reproducibility of the image data. The color correction process is realized by creating an LUT (look-up table) of input values (RGB) and output values (CMY) associated with one another and looking up the output values in the created LUT.

Further, in the single-color mode or two-color mode, as shown in (a) and (b) of FIG. 9, the color correction section 13 performs no processing on the CMY image data sent from the two-color printing process section 12 and passes the image data directly on to the black generation and under color removal section 14.

The black generation and under color removal section 14 is a block that, in the full-color mode or two-color mode, receives CMY image data from the color correction section 13, generates black (K) image data from the CMY image data, and generate new CMY image data by subtracting the black (K) image data from the original CMY image data. Thus, in the full-color mode or two-color mode, as shown in FIG. 8 or (b) of FIG. 9, the black generation and under color removal section 14 converts the CMY image data into four colors of image data CMYK.

Further, in the single-color mode, as shown in (a) of FIG. 9, the black generation and under color removal section 14 performs no processing on the CMY image data sent from the color correction section 13 and passes the image data directly on to the subsequent spatial filter section 15.

In the full-color mode or two-color mode, the output from the black generation and under color removal section 14 and the input to and output from each block subsequent to the black generation and under color removal section 14 are CMYK image data as shown in FIG. 8. Meanwhile, in the single-color mode, the output from the black generation and under color removal section 14 and the input to and output from each block subsequent to the black generation and under color removal section 14 are CMY image data unlike in FIG. 8.

The spatial filter section 15 receives the CMYK or CMY image data from the black generation and under color removal section 14 and performs a spatial filter process (e.g., edge enhancement process, smoothing process) on the image data by a digital filter in accordance with the segmentation class signals. That is, the spatial filter section 15 executes image processing differently for each image area in accordance with the segmentation class signals.

The enlarging/reducing section 16 is a block that enlarges or reduces an image in accordance with an enlarging/reducing command (information indicating the zoom ratio of a printed image) inputted by the user from the operation panel (not shown).

The output tone correction section 17 is a block that receives image data from the enlarging/reducing section 16 and performs output gamma correction for outputting the image data onto a recording medium such as a sheet of paper: The halftone generation section 18 executes, by dithering or error diffusion, a tone reproduction process (halftone generation process) necessary for the printing section 103 to print an image.

Then, the halftone generation section 18 passes the CMYK or CMY image data on to the printing section 103, and the printing section 103 prints an image of the image data onto a recording medium (e.g., a sheet of paper).

(1-2) Preview Display

Next, the processes that are executed by the blocks of the image processing apparatus 102 in cases where a preview of an image to be printed is displayed in the copy mode are described with reference to FIG. 10. FIG. 10 is a block diagram showing the same image forming apparatus 100 as in FIG. 8 and showing the flow of image data at the time of a preview display process in the copy mode and the full-color mode.

It should be noted that because the A/D (analog/digital) conversion section 2, the shading correction section 3, the input processing section 4, the automatic document type discrimination section 5, the segmentation process section 6, the compression section 7, the segmentation class signal compression section 8, the decompression section 9, the image-quality adjustment section 11, and the two-color printing process section 12 perform the same processes as in the case of a printing process, such processes will not be described below.

At the time of a preview display, as shown in FIG. 10, the segmentation class signal decompression section 10 decompresses (decodes) segmentation class signals and passes them on to the spatial filter section 15 and the output tone correction section 17.

In the full-color mode, the color correction section 13 receives RGB image data in color space of the scanner (image input apparatus 101). Then, the color correction section 13 converts the RGB image data into R′G′B′ image data in color space of the image display device 104.

That is, the color correction section 13 converts the RGB image data, which conforms to the image scanning characteristics of the scanner, into the R′G′B′ image data, which conforms to the display characteristics of the display device. It should be noted that the conversion of the RGB image data into the R′G′B′ image data is also realized by creating an LUT (look-up table) of input values (RGB) and output values (R′G′B′) associated with one another and looking up the output values in the created LUT.

Moreover, in the full-color mode, the present reference example uses the same image processing circuit for the conversion of RGB image data into CMYK image data at the time of a printing process and the conversion of RGB image data into R′G′B′ image data at the time of a preview display.

As with FIG. 8, FIG. 10 shows the image forming apparatus 100 in the full-color mode. In the full-color mode, the color correction section 13 receives RGB image data. Meanwhile, in the single-color mode or two-color mode, as shown in (a) and (b) of FIG. 11, the color correction section 13 receives CMY image data. (a) of FIG. 11 shows some blocks of the image processing apparatus 102 performing a preview display process in the copy mode and the singe-color mode, and (b) of FIG. 11 shows some blocks of the image processing apparatus 102 performing a preview display process in the copy mode and the two-color mode.

Then, in the single-color mode or two-color mode, the color correction section 13 converts the CMY image data into R′G′B′ image data. That is, the color correction section 13 converts the CMY image data, which conforms to the printing characteristics of the printing process, into the R′G′B′ image data, which conforms to the display characteristics of the display device. It should be noted that the conversion of the CMY image data into the R′G′B′ image data is also realized by creating an LUT (look-up table) of input values (RGB) and output values (R′G′B′) associated with one another and looking up the output values in the created LUT.

In any one of the single-color mode, the two-color mode, and the full-color mode, as shown in FIGS. 10 and 11, the black generation and under color removal section 14 performs no processing on the R′G′B′ image data sent from the color correction section 13 and passes the image data directly on to the subsequent spatial filter section 15.

The spatial filter section 15 receives the R′G′B′ image data from the black generation and under color removal section 14 and performs a spatial filter process (e.g., edge enhancement process, smoothing process) on the image data by a digital filter in accordance with the segmentation class signals. That is, as in the case of a printing process, the spatial filter section 15 executes image processing differently for each image area in accordance with the segmentation class signals.

The enlarging/reducing section 16 performs a downsampling process by which the number of pixels of an image composed of the R′G′B′ image data sent from the spatial filter section 15 is converted into the number of pixels of the image display device 104 (process by which the number of pixels is reduced). The image display device 104, provided in the operation panel of the image forming apparatus 100, is lower in resolution than image data to be printed and, usually, is an extremely small display. Therefore, at the time of a preview display, it is necessary to downsample the image data. Further, the enlarging/reducing section 16 enlarges or reduces the image in accordance with an enlarging/reducing command (information indicating the zoom ratio of a display, e.g., a fixed zoom ratio of 2 to 4 times) inputted from the operation panel (not illustrated) provided in the image forming apparatus 100.

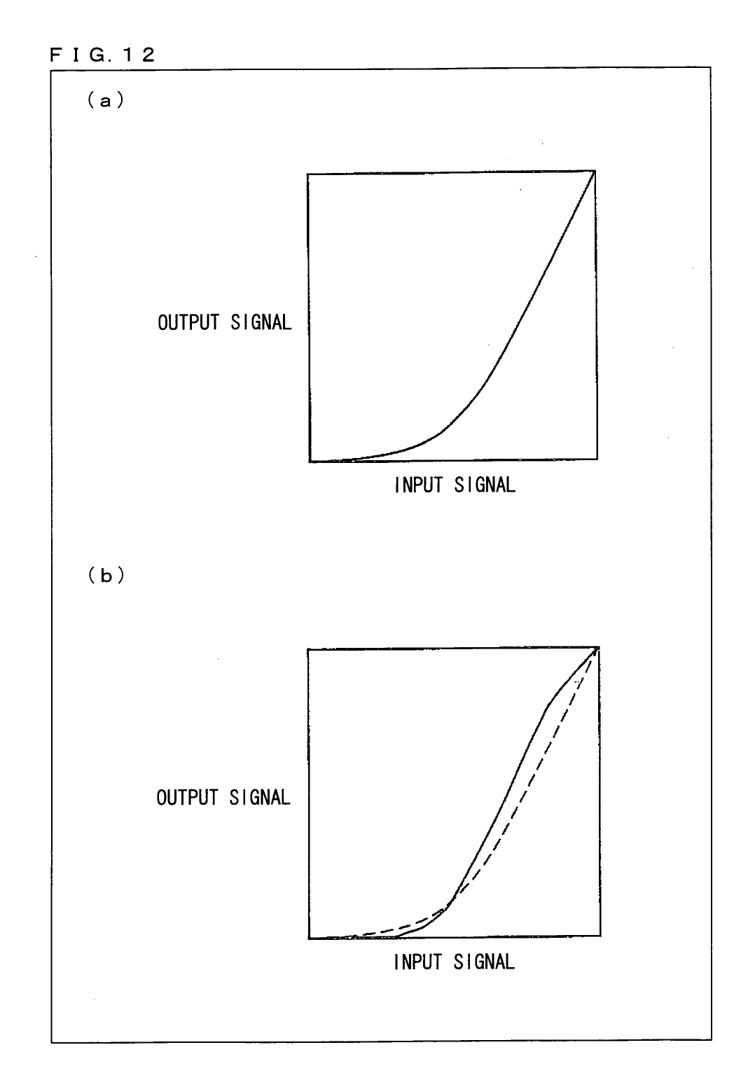

The output tone correction section 17 receives the image data from the enlarging/reducing section 16 and performs output gamma correction on the image data in accordance with the segmentation class signals. More specifically, in accordance with the segmentation class signals, the output tone correction section 17 selects different gamma curves for different image areas and varies in output gamma correction from one image area to another. For example, for non-text areas, the output tone correction section 17 selects a gamma curve corresponding to the display characteristics of the image display device 104, and for text areas, selects a gamma curve for texts to be sharply displayed. (a) of FIG. 12 shows a gamma curve corresponding to the display characteristics of the image display device 104, and (b) of FIG. 12 shows a solid line representing a gamma curve for texts to be sharply displayed and a dotted line representing a gamma curve corresponding to the display characteristics of the image display device 14. The dotted line is shown for comparison with the gamma curve for texts to be sharply displayed.

In the present reference example, the output tone correction section 17 selects between the gamma curves in accordance with the segmentation class signals. However, the output tone correction section 17 may perform output tone correction by using only the gamma curve of (a) of FIG. 12, instead of making selection in accordance with the segmentation class signals.

Then, the halftone generation section 18 performs no processing on the R′G′B′ image data sent from the output tone correction section 17 and passes the image data directly on to the subsequent image display device 104. This allows the image display device 104 to display, in accordance with the R′G′B′ image data, a preview of an image to be copied.

It should be noted that in place of the output tone correction section 17, the image-quality adjustment section 11 may execute output gamma correction.

(1-3) As to Whether the Blocks Operate or do not Operate

As described above, at the time of printing in the full-color mode, the image-quality adjustment section 11 through the halftone generation section 18 all operate except for the two-color printing process section 12 (see FIG. 8). Meanwhile, at the time of a preview display in the full-color mode, the image-quality adjustment section 11 through the halftone generation section 18 all operate except for the two-color printing process section 12, the black generation and under color removal section 14, and the halftone generation section 18 (see FIG. 10).

Further, at the time of printing in the two-color mode, the image-quality adjustment section 11 through the halftone generation section 18 all operate except for the color correction section 13 (see (b) of FIG. 9). Meanwhile, at the time of a preview display in the two-color mode, the image-quality adjustment section 11 through the halftone generation section 18 all operate except for the black generation and under color removal section 14 and the halftone generation section 18 (see (b) of FIG. 11).

Furthermore, at the time of printing in the single-color mode, the image-quality adjustment section 11 through the halftone generation section 18 all operate except for the two-color printing process section 12, the color correction section 13, and the black generation and under color removal section 14 (see (a) of FIG. 9). Meanwhile, at the time of a preview display in the single-color mode, the image-quality adjustment section 11 through the halftone generation section 18 all operate except for the two-color printing process section 12, the black generation and under color removal section 14, and the halftone generation section 18 (see (a) of FIG. 11).

(1-4) Steps of a Process

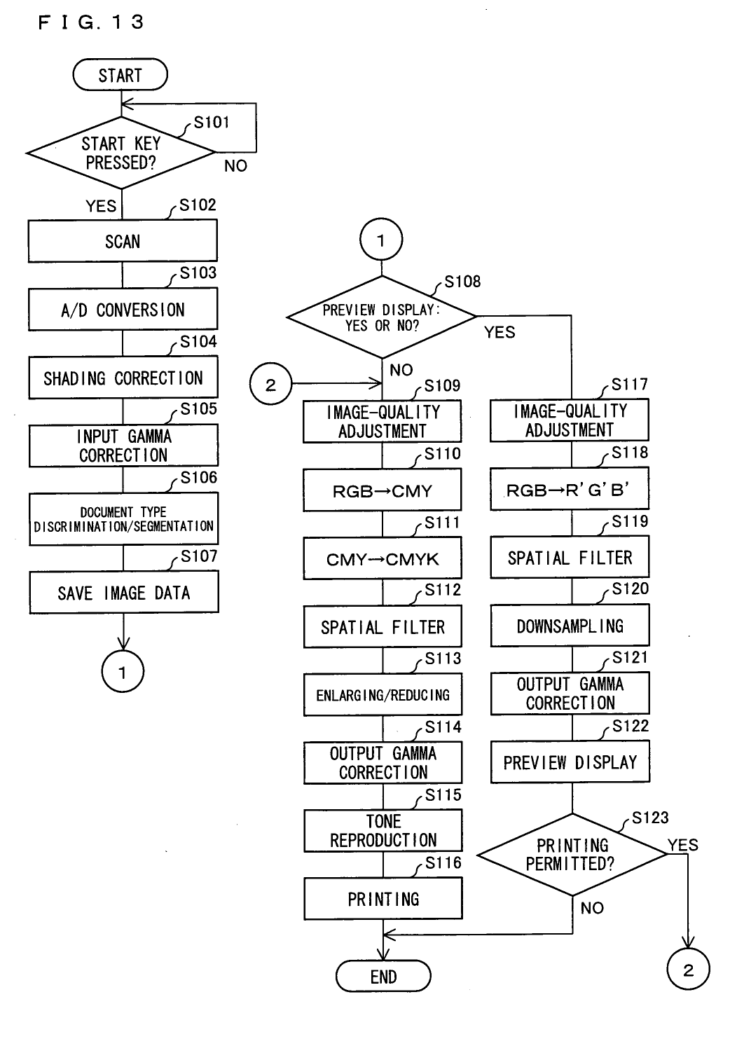

Next, an example of steps of a process in the copy mode and the full-color mode is described with reference to FIG. 13. FIG. 13 is a flowchart showing an example of steps of a process that is performed by the image forming apparatus in the copy mode and the full-color mode.

In response to a pressing of a start key (YES in S101) in the copy mode, the image forming apparatus 100 generates RGB analog signals by scanning a document (S102). It is assumed here that prior to the pressing of the start key in S101, the user inputs setting information indicating whether or not a preview display is necessary and thereby sets whether or not the image forming apparatus 100 performs a preview display.

After S102, the image forming apparatus 100 converts the RGB analog signals into RGB image data (digital data) (S103), subjects the RGB image data to shading correction (S104), and then subjects the RGB image data to input gamma correction (S105). After S105, the image forming apparatus 100 performs a document type discrimination process and a segmentation process in accordance with the RGB image data (S106), and then stores the RGB image data in the storage device 107 (S107).

After S107, the image forming apparatus 100 judges whether or not it has been set to “Preview Display: Yes” (S108). In cases where it has not been set to “Preview Display: Yes”, the image forming apparatus 100 executes Steps S109 through S116. In cases where it has been set to “Preview Display: Yes”, the image forming apparatus 100 executes Steps S117 through S123. In the following, Steps S109 through S116 are described first, and then Steps S117 through S123 are described.

In cases where the image forming apparatus 100 has not been set to “Preview Display: Yes” (NO in S108), the image forming apparatus 100 reads out the RGB image data from the storage device 107, and then performs an image-quality adjustment process such as background removal correction and adjustment of intensity (S109). After that, the image forming apparatus 100 converts the RGB image data, which conforms to the characteristics of the scanner, into CMY image data conforming to the characteristics of the printer (S110), and then converts the CMY image data into CMYK image data (S111). After that, the image forming apparatus 100 performs a spatial filter process on the CMYK image data in accordance with a result of the segmentation process (S112), and then performs an enlarging/reducing process on the CMYK image data (S113). After S113, the image forming apparatus 100 performs output gamma correction and a tone reproduction process on the CMYK image data (S114, S115), prints an image of the image data on a sheet of paper (S116), and then finishes the process.

In cases where the image forming apparatus 100 judges, in S108, that it has been set to “Preview Display: Yes” (YES in S108), the image forming apparatus 100 reads out the RGB image data from the storage device 107, and then performs the same image-quality adjustment process as in S109 (S117). After that, the image forming apparatus 100 converts the RGB image data, which conforms to the characteristics of the scanner, into R′G′B′ image data conforming to the characteristics of the display device (S118). After S118, the image forming apparatus 100 performs a spatial filter process on the R′G′B′ image data in accordance with a result of the segmentation process (S119), and then performs a downsampling process on the R′G′B′ image data so that the R′G′B′ image data conforms to the resolution and size of the display (S120). After S120, the image forming apparatus 100 performs output gamma correction on the R′G′B′ image data in accordance with the result of the segmentation process (S121). After S121, the image forming apparatus 100 performs a preview display in accordance with the R′G′B′ image data (S122). Then, after S122, upon receiving, from the user, a command indicating permission of printing (YES in S123), the image forming apparatus 100 again reads out the RGB image data from the storage device 107, and then performs printing by executing Steps S109 through S116 in accordance with the image data. On the other hand, after S122, upon receiving, from the user, a command indicating cancellation of printing (NO in S123), the image forming apparatus 100 finishes the process.

(2) Facsimile Transmission Mode

(2-1) Transmission Process

FIG. 14 is a block diagram showing the same image forming apparatus 100 as in FIG. 8 and showing the flow of image data in a transmission process in the facsimile [symbol] transmission mode. It should be noted that because the A/D (analog/digital) conversion section 2, the shading process section 3, the input processing section 4, the automatic document type discrimination section 5, the segmentation process section 6, the compression section 7, the segmentation class signal compression section 8, and the decompression section 9 performs the same processes as in the case of the copy mode, such processes will not be described below.

In the facsimile transmission mode, the segmentation class signal decompression section 10 reads out the segmentation class signal codes from the storage device 107, decompresses the segmentation class signal codes, and then transmits the decompressed (decoded) segmentation class signal codes to the spatial filter section 15.

The image-quality adjustment section 11 receives the RGB image data from the decompression section 9 and converts the RGB image data into K image data (a value indicating grayscale). It should be noted that this conversion is performed by using a predetermined matrix of coefficients and Eq. (2) below:

Luminance(Value of K Image Data)=0.299r+0.587g+0.114b Eq. (2)

where r is the value (density) of red image data, g is the value of green image data, and b is the value of blue image data.

The two-color printing process section 12, the color correction section 13, and the black generation and under color removal section 14 perform no processing on the K image data (signal) sent from the image-quality adjustment section 11 and pass the K image data directly on to the subsequent spatial filter section 15.

The spatial filter section 15 performs a spatial filter process (e.g., edge enhancement process, smoothing process) on the K image data by a digital filter in accordance with the segmentation class signals. The enlarging/reducing section 16 performs an enlarging/reducing process on the K image data in accordance with the transmission resolution. The output tone correction section 17 performs output gamma correction (gamma correction for output onto a recording medium such as a sheet of paper) on the K image data sent from the enlarging/reducing section 16. The halftone generation section 18 converts the K image data into binarized image data, for example, by error diffusion. Then, the binarized image data are rotated by a rotation process section (not shown) as needed, compressed by a compression/decompression section (not shown) into a predetermined form, and then stored in a memory (not shown).

After that, the transmitting device (e.g., modem) 106 performs a procedure for transmission to the destination and ensures transmittability to the destination. Then, the transmitting device 106 reads out the binarized image data, stored in the memory, with the binarized image data compressed in the predetermined form, subjects the binarized image data to necessary processes such as a conversion in compression format, and then transmits the binarized image data in sequence via a communication line.

(2-2) Preview Display

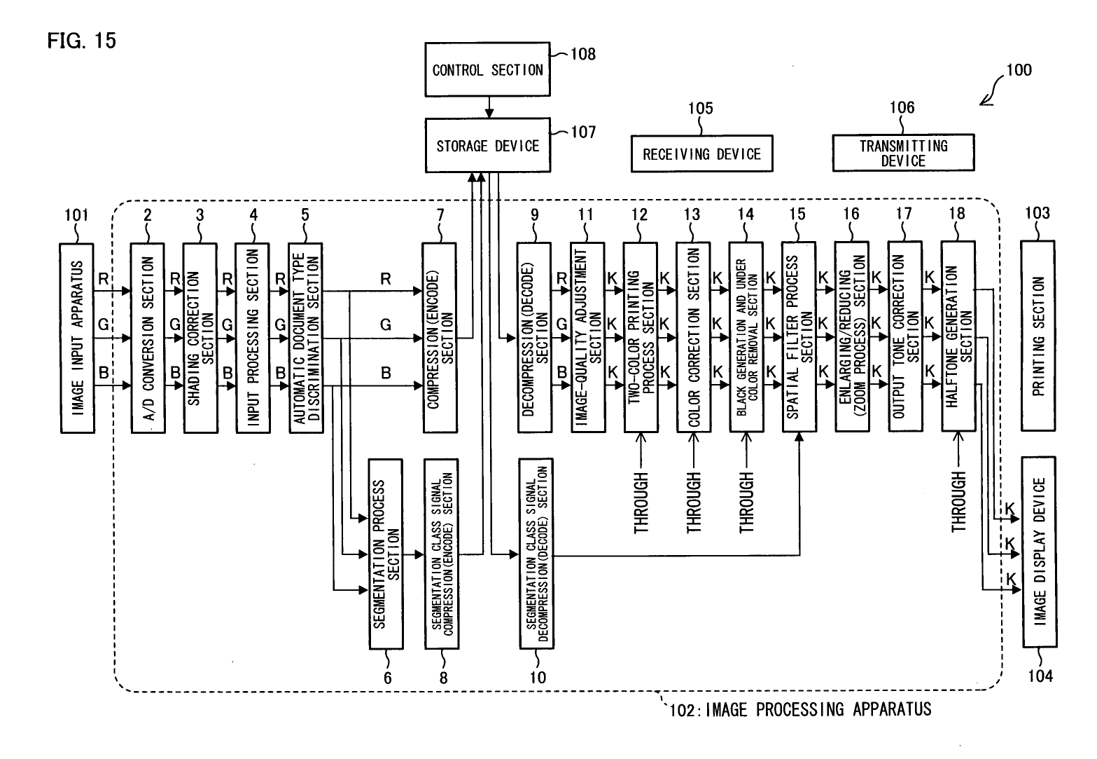

FIG. 15 is a block diagram showing the same image forming apparatus 100 as in FIG. 8 and showing the flow of image data in a preview display process in the facsimile transmission mode. The term “preview display in the facsimile transmission mode” here means a process of, before transmitting an image by facsimile, displaying a preview of the image to be transmitted by facsimile.

At the time of a preview display, the A/D conversion section 2, the shading correction section 3, the input processing section 4, the automatic document type discrimination section 5, the segmentation process section 6, the compression section 7, the segmentation class signal compression section 8, the decompression section 9, the segmentation class signal decompression section 10, the image-quality adjustment section 11, and the spatial filter section 15 perform the same processes as in the case of a facsimile transmission process; therefore, such processes are not described. Further, as in the case of a facsimile transmission process, the two-color printing process section 12, the color correction section 13, and the black generation and under color removal section 14 do not perform any processes.

However, at the time of a preview display, unlike in the case of a transmission process, as shown in FIG. 15, three pieces of K image data (all being equal in value) are transmitted for each pixel all the way from the image-quality adjustment section 11 to the image display device 104. This is because the image display device 104 is a full-color model and as such requires three values (pieces of image data) for one pixel.

The enlarging/reducing section 16 performs a downsampling process on the K image data so that the number of pixels of an image composed of the K image data sent from the spatial filter section 15 conforms to the number of pixels of the display size of the image display device 104. Further, the enlarging/reducing section 16 enlarges or reduces the image in accordance with an enlarging/reducing command (information indicating the zoom ratio of a display, e.g., a fixed zoom ratio of 2 to 4 times) inputted from the operation panel (not shown) provided in the image forming apparatus 100.

The output tone correction section 17 receives the K image data from the enlarging/reducing section 16 and performs gamma correction on the K image data in conformity to the display characteristics of the image display device 104. Then, the halftone generation section 18 performs no processing on the K image data sent from the output tone correction section 17 and passes the K image data directly on to the subsequence image display device 104. This allows the image display device 104 to display, in accordance with the K image data, a preview of an image to be transmitted by facsimile.

Further, at the time of a preview display process in the facsimile transmission mode, the image-quality adjustment section 11 converts the RGB image data into three pieces of K image data. However, there is no such limitation in embodiment. For example, it is possible to perform image processing without converting RGB image data into K image data up to the output tone correction section 17, to receive the RGB image data from the output tone correction section 17, and to convert the RGB image data into K image data by a browser.

(2-3) As to Whether the Blocks Operate or do not Operate

As described above, at the time of a transmission process in the facsimile transmission mode, the image-quality adjustment section 11 through the halftone generation section 18 all operate except for the two-color printing process section 12, the color correction section 13, and the black generation and under color removal section 14 (see FIG. 14). Meanwhile, at the time of a preview display in the facsimile transmission mode, the image-quality adjustment section 11 through the halftone generation section 18 all operate except for the two-color printing process section 12, the color correction section 13, the black generation and under color removal section 14, and the halftone generation section 18 (see FIG. 15).

(2-4) Steps of a Process

Next, an example of steps of a process in the facsimile transmission mode is described. In cases where the image forming apparatus 100 receives a fax transmission command from the user with the image forming apparatus 100 having not been set to “Preview Display: Yes”, the image forming apparatus 100 processes image data as shown in FIG. 14 and transmits the image data to an external apparatus.

Meanwhile, in cases where the image forming apparatus 100 receives a fax transmission command from the user with the image forming apparatus 100 set to “Preview Display: Yes”, the image forming apparatus 100 processes image data as shown in FIG. 15, thereby storing the image data in the storage device 107 and displaying a preview of an image of the image data on the image display device 104. Then, when the image forming apparatus 100 receives a transmission permission command from the user with the preview being displayed, the image forming apparatus 100 reads out the image data from the storage device 107, processes the image data in the decompression section 9 through the halftone generation section 18 as shown in FIG. 14, and transmits the image data to an external apparatus via the transmitting device 106.

(3) Facsimile Reception Mode

(3-1) Printing Process

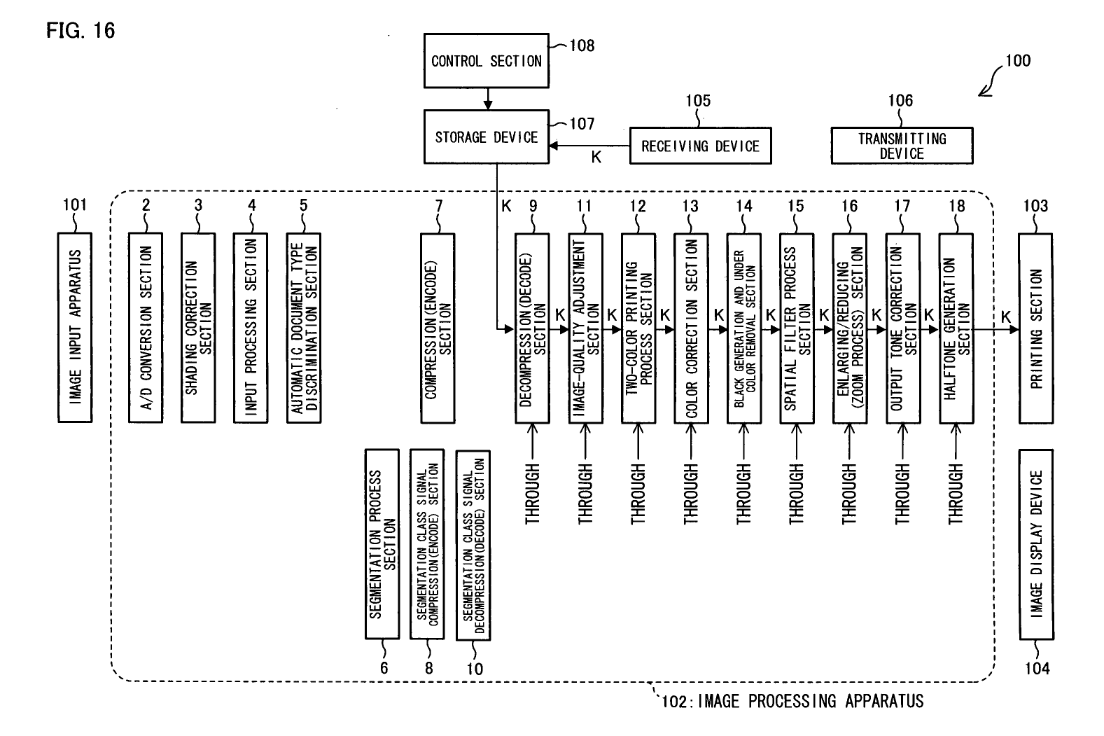

FIG. 16 is a block diagram showing the same image forming apparatus 100 as in FIG. 8 and showing the flow of image data in a printing process in the facsimile reception mode.

In the case of facsimile reception, the receiving device 105 receives K image data (1 bit) from the source while performing a communication procedure. Then, the K image data received by the receiving device 105 are decompressed by the compression/decompression section (not shown), rotated by the rotation process section (not shown) as needed, and then subjected to a resolution conversion process by a resolution conversion section (not shown). After that, the image data are stored temporarily in the storage device 107.

Furthermore, the image data written in the storage device 107 are passed on to the decompression section 9 of the image processing apparatus 102 by the control section 108. The decompression section 9, the image-quality adjustment section 11, the two-color printing process section 12, the color correction section 13, the black generation and under color removal section 14, the spatial filter section 15, the enlarging/reducing section 16, the output tone correction section 17, and the halftone generation section 18 perform no processing on the image data sent from the storage device 107 and pass the image data directly onto the subsequent printing section 103. The printing section 103 forms an image on a recording medium (e.g., a sheet of paper) in accordance with the K image data sent from the halftone generation section 18. In the case of a printing process in the facsimile reception mode, image processing is not performed as described above. Therefore, the image data stored in the storage device 107 may be outputted directly to the printing section 103.

(3-2) Preview Display

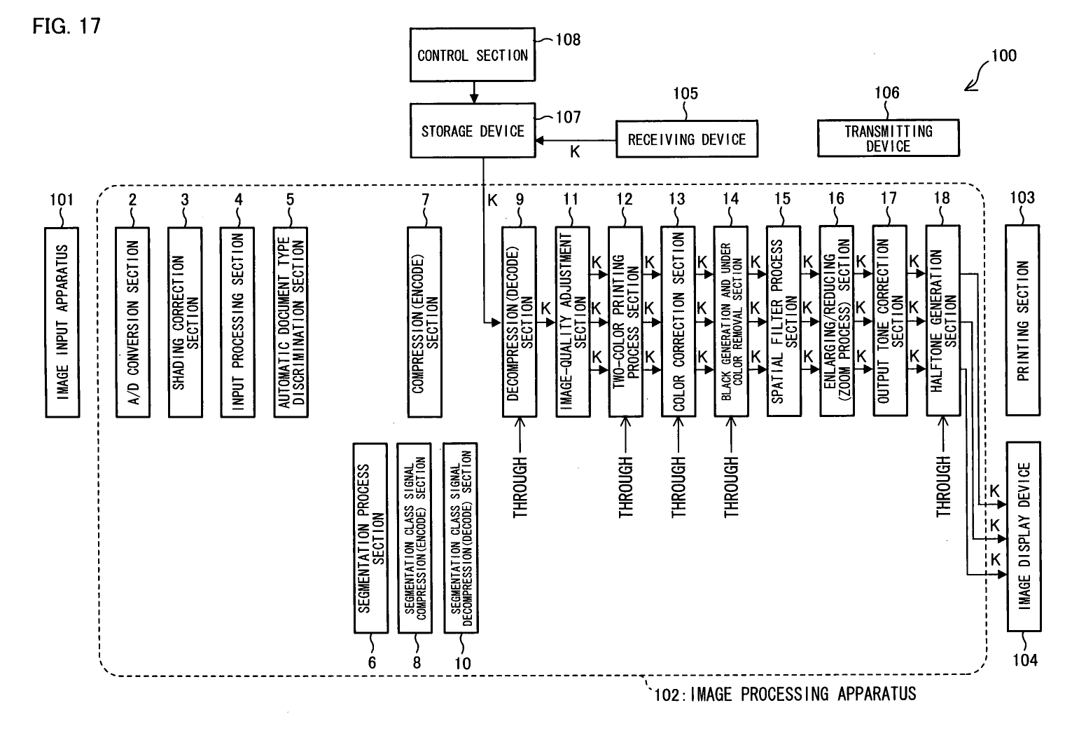

FIG. 17 is a block diagram showing the same image forming apparatus 100 as in FIG. 8 and showing the flow of image data in a preview display process in the facsimile reception mode. The term “preview display in the facsimile reception mode” here means a process of, before printing an image of image data received by facsimile, displaying a preview of the image to be printed.

Also at the time of a preview display in the facsimile reception mode, as in the case of a printing process in the facsimile reception mode, the image data written in the storage device 107 are passed on to the decompression section 9 of the image processing apparatus 102 by the control section 108. The decompression section 9 performs no processing on the image data sent from the storage device 107 and passes the image data on to a bit-number conversion process section (not shown). Then, the bit-number conversion process section converts the number of bits of the image data sent from the decompression section 9 (e.g., from 1 bit to 8 bits), and then passes the image data on to the subsequent image-quality adjustment section 11. That is, although not shown in FIG. 17, the decompression section 9 and the image-quality adjustment section 11 has the bit-number conversion section provided therebetween.

As shown in FIG. 17, for each pixel, the image-quality adjustment section 11 receives one piece of K image data and generates and outputs three pieces of K image data (all being equal in value). This is because the image display device 104 is a full-color model and as such requires three values for one pixel.

After that, the two-color printing process section 12, the color correction section 13, and the black generation and under color removal section 14 perform no processing on the K image data sent from the image-quality adjustment section 11 and pass the image data directly on to the subsequent spatial filter section 15. The spatial filter section 15 performs a blur (smoothing) process and the like on the K image data with use of a digital filter.

The enlarging/reducing section 16 performs a downsampling process on the K image data so that the number of pixels of an image of the K image data sent from the spatial filter section 15 conforms to the number of pixels of the display size of the image display device 104. Further, the enlarging/reducing section 16 enlarges or reduces the image in accordance with an enlarging/reducing command (information indicating the zoom ratio of a display, e.g., a fixed zoom ratio of 2 to 4 times) inputted from the operation panel (not shown) provided in the image forming apparatus 100.

The output tone correction section 17 receives the K image data from the enlarging/reducing section 16 and performs output gamma correction on the K image data in conformity to the display characteristics of the image display device 104. Then, the halftone generation section 18 performs no processing on the K image data sent from the output tone correction section 17 and passes the K image data directly on to the subsequence image display device 104. This allows the image display device 104 to display, in accordance with the K image data, a preview of an image received by facsimile.

(3-3) As to Whether the Blocks Operate or do not Operate

As described above, at the time of a printing process in the facsimile reception mode, the image-quality adjustment section 11 through the halftone generation section 18 do not operate (see FIG. 16). Meanwhile, at the time of a preview display in the facsimile reception mode, the image-quality adjustment section 11 through the halftone generation section 18 all operate except the two-color printing process section 12, the color correction section 13, the black generation and under color removal section 14, and the halftone generation section 18 (see FIG. 17).

(3-4) Steps of a Process

Next, an example of steps of a process in the facsimile reception mode is described. In cases where the image forming apparatus 100 receives image data by facsimile, the received image data is written temporarily in the storage device 107. It should be noted here that there is a time lag between the writing of the image data in the storage device 107 and printing of an image. In cases where the user inputs a “preview command” during the time lag, the image data is processed along such a flow as shown in FIG. 10, and a preview of an image of the image data is displayed by the image display device 104. Further, when the image is printed, the image data is processed along such a flow as shown in FIG. 9, and the image of the image data is printed by the printing section 103.

(4) Image Transmission Mode

(4-1) Transmission Process

In the case of operation of the image forming apparatus 100 at the time of a transmission process in the image transmission mode, the image input apparatus 101, the A/D (analog/digital) conversion section 2, the shading correction section 3, the input processing section 4, the automatic document type discrimination section 5, the segmentation process section 6, the compression section 7, the segmentation class signal compression section 8, and the decompression section 9 performs the same processes as in the case of the copy mode. It should be noted that the segmentation class signal decompression section 10 supplies the segmentation class signals to the spatial filter section 15 and the output tone correction section 17.

Then, the image-quality adjustment section 11 performs a background removal process and color balance adjustment. The color correction section 13 converts the image data into R″G″B″ image data (e.g., sRGB data) conforming to the display characteristics of a commonly-used display device. The spatial filter section 15 performs a spatial filter process (edge enhancement process, smoothing process) by a digital filter in accordance with the segmentation class signals. The enlarging/reducing section 16 enlarges or reduces the image. Further, the output tone correction section 17 performs correction on a text area with use of the gamma curve of (b) of FIG. 12, and performs correction on a non-text area with use the gamma curve of (a) of FIG. 12, for example. The two-color printing process section 12 and the black generation and under color removal section 14 perform no processing on the input image data, and each of the blocks passes the image data directly on to the subsequent block. Therefore, the output tone correction section 17 outputs the R″G″B″ image data.

Furthermore, the R″G″B″ image data from the output tone correction section 17 are converted into an image file such as a PDF file by a format conversion process section (not shown). Then, in the scan to e-mail mode, which is an image transmission mode, the image file is attached to an e-mail by the mail processing section (job apparatus; not shown), and the e-mail is transmitted to the destination via a network. Alternatively, in the scan to ftp mode, which is another image transmission mode, the image file is transmitted to a predetermined folder. Alternatively, in the scan to usb mode, which is the other image transmission mode, the image file is transmitted to a predetermined USB memory.

(4-2) Preview Display

In the case of operation of the image forming apparatus 100 at the time of a preview display in the image transmission mode, the image input apparatus 101, the A/D conversion section 2, the shading correction section 3, the input processing section 4, the automatic document type discrimination section 5, the segmentation process section 6, the compression section 7, the segmentation class signal compression section 8, the decompression section 9, the segmentation class signal decompression section 10, the image-quality adjustment section 11, and the two-color printing process section 12 perform the same processes as in the case of transmission in the image transmission mode.

Then, at the time of a preview display in the image transmission mode, the color correction section 13 converts the RGB image data into R′G′B′ image data conforming to the color space of the image display device 104.

After that, as in the case of transmission, the spatial filter section 15 performs a spatial filter process (edge enhancement process, smoothing process) by a digital filter in accordance with the segmentation class signals. The enlarging/reducing section 16 performs a downsampling process for a match in size for the image display device 104. Further, the output tone correction section 17 performs correction on a text area with use of the gamma curve of (b) of FIG. 12, and performs correction on a non-text area with use the gamma curve of (a) of FIG. 12, for example.

Then, the output tone correction section 17 supplies the R′G′B′ image data to the image display device 104, and the image display device 104 performs a preview display in accordance with the R′G′B′ image data.

(5) Modification

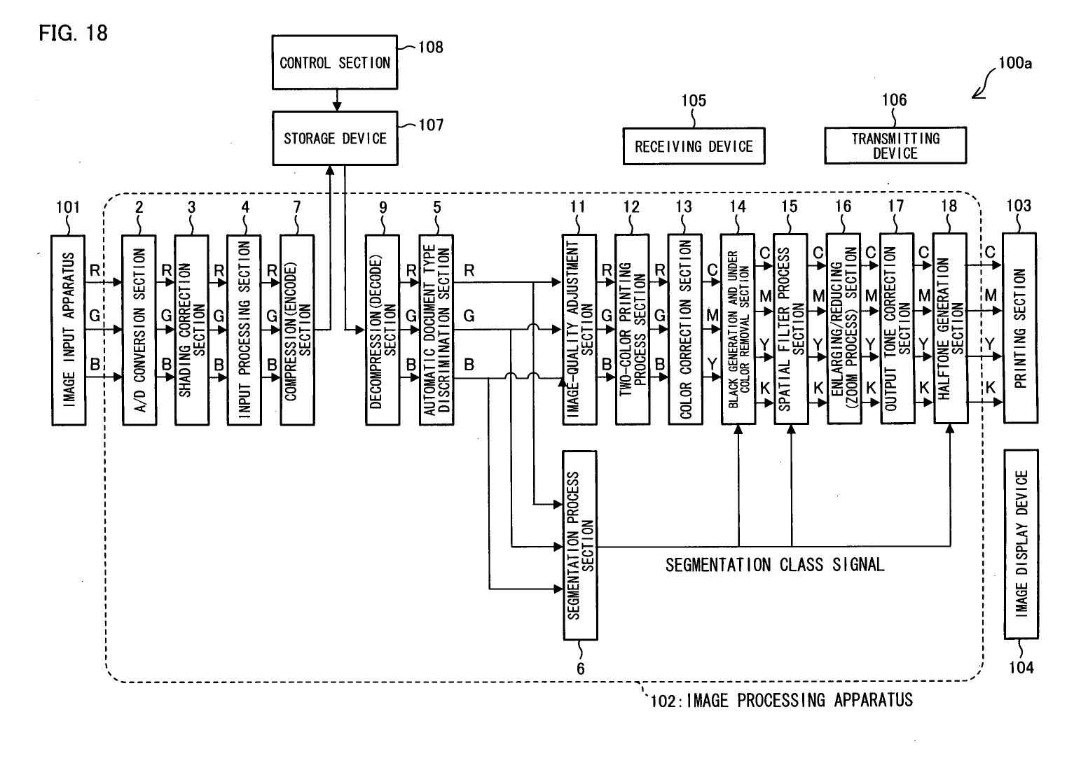

In the image forming apparatus 100 of FIG. 8, the compressed image data (encoded codes) and the segmentation class signal codes are stored in the storage device 107 in association with one another. However, as in an image forming apparatus 100a of FIG. 18, there may be such an arrangement that: after the image input apparatus 101 reads image data, the image data are encoded and stored temporarily in the storage device 107 before a segmentation process and an automatic document type discrimination process; and the image data are read out from the storage device 107, decompressed, and then subjected to a segmentation process and an automatic document type discrimination process.

Further, the image forming apparatus 100 of FIG. 8 may be capable of executing an image filing process during a job such as the copy mode, the print mode, the facsimile transmission mode, the facsimile reception mode, or the image transmission mode. The image filing process is a process in which to create an image file (e.g., JPEG or TIFF file), during a job such as the copy mode, in accordance with image data obtained by the image input apparatus 101 or image data received from outside and store the image file in the storage device 107.

At the time of filing in the image filing process, the image data obtained by the image input apparatus 101 or the image data received from outside are converted into an image file (e.g., JPEG or TIFF file) by the image processing apparatus 102. The image filed is sent to a filing processing section (not shown). The filing processing section stores the image file in the storage device 107.

Further, in the case of a preview during each mode (e.g., the copy mode, the print mode, or the facsimile transmission mode), the image data obtained by the image input apparatus 101 or the image data received from outside are processed by the image processing apparatus 102, and then sent to the image display device 104, regardless of the execution of the image filing process. Furthermore, in the case of a preview during each mode, the image processing apparatus 102 executes the same image processing regardless of the execution of the image filing process. For example, at the time of a preview display in the copy mode, the image processing apparatus 102 performs such processes as shown in FIG. 10, regardless of the execution of the image filing process. Further, at the time of a preview display in the facsimile transmission mode, the image processing apparatus 102 performs such processes as shown in FIG. 15, regardless of the execution of the image filing mode.

(6) Advantages of the Image Processing Apparatus of the Present Reference Example

The image processing apparatus 102 of the present reference example supplies image data to the printing section (printing apparatus) 103, which performs printing in the copy mode or print mode, and supplies the image data to the image display device 104 so that the image display device 104 displays a preview before the execution of printing.

Moreover, the image processing apparatus 102 includes a first image processing section which performs first image processing on image data to be supplied to the printing section 103, which performs second image processing on image data to be supplied to the image display device 104, the second image processing being different from the first image processing, and which performs the first image processing and the second image processing with use of a common circuit area. An example of the first image processing section is the color correction section 13 in the copy mode and the full-color mode. This is because the color correction section 13 uses a common circuit area for a process of conversion (the first image processing) from RGB into CMY and a process (the second image processing) of conversion from RGB into R′G′B′.

This brings about a merit of reducing the circuit size of an image processing circuit even in an image processing apparatus that performs image processing for a printing process or the like and image processing for a preview before the printing process.

Further, in the present reference example, at the time of printing in the copy mode and the full-color mode, the color correction section 13 performs a process by which additive image data (RGB) read by the scanner and conforming to the characteristics of the scanner are converted into subtractive image data (CMY) conforming to the characteristics of the printing section 103. Meanwhile, at the time of a preview in the copy mode and the full-color mode, the color correction section 13 performs a process by which the additive image data (RGB) read by the scanner and conforming to the characteristics of the scanner are converted into additive image data (R′G′B′) conforming to the characteristics of the image display device 104. That is, at the time of a preview display, the additive image data conforming to the characteristics of the scanner are converted directly into the additive image data conforming to the characteristics of the image display device 104. Therefore, at the time of a preview display in the copy mode and the full-color mode, the image processing apparatus 102 of the present reference example performs a single nonlinear conversion from the RGB image data into the R′G′B′ image data, but does not perform a plurality of nonlinear conversions as in the arrangement of Japanese Patent Application Publication, Tokukaihei, No. 9-135316 A (1997), thus making it possible to suppress accumulation of errors in conversion and suppress deterioration in color reproducibility. In Japanese Patent Application Publication, Tokukaihei, No. 9-135316 A (1997), a total of four conversions are performed, namely the conversion from RGB data into CMY data, the conversion from CMY data into CMYK data, the conversion from CMYK data into CMY data, and the conversion from the CMY data into RGB data, which result in accumulation of errors in conversion and deterioration in color reproducibility.

Further, at the time of a preview in the copy mode and the single-color mode or at the time of a preview in the copy mode and the two-color mode, the present reference example performs such a nonlinear conversion, but the number of such nonlinear conversions is only two. Therefore, it is possible to better suppress deterioration in color reproducibility than in the arrangement of Japanese Patent Application Publication, Tokukaihei, No. 9-135316 A (1997), in which a total of four nonlinear conversions are performed.

Furthermore, in the present reference example, at the time of printing in the copy mode and the full-color mode, the black generation and under color removal section 14 converts CMY image data into CMYK image data; meanwhile, at the time of a preview display in the copy mode and the full-color mode, the black generation and under color removal section 14 performs no processing on R′G′B′ and outputs R′G′B′ directly. This makes it possible to simplify the circuit configuration by using a common image data path in the image processing circuit for printing image data that needs to be converted from CMY into CMYK (black generation and under color removal process) and preview image data that does not need to be subjected to a black generation and under color removal process.

The image processing apparatus 102 of the present reference example can perform image processing based on a result of judgment by the automatic document type discrimination section 5, image processing based on a result of processing by the segmentation process section 6, and a background removal process. The effects of these processes are reflected in a preview image that is displayed by the image display device 104.

### INDUSTRIAL APPLICABILITY

The control apparatus of the present invention can be used as an apparatus for controlling image output apparatuses, such as a multifunction printer, a copying machine, a printer, a facsimile device, and a scanning machine capable of transmitting an image.

### REFERENCE SIGNS LIST

50 Multifunction Printer (Image Output Apparatus)
53 Printing Section
54 Storage Device
55 Transmitting Device
56 Receiving Device
57a Display Section
59 Control Apparatus
59a Image Transmitting Section
59c Job Controlling Section
59d notification section

1. A control apparatus (i) which controls an image output apparatus that executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, the control apparatus comprising:
a job controlling section which selects a control process from a first control process of causing the image output apparatus to execute a job corresponding to a preview displayed on the display section and a second control process of causing the job corresponding to the preview displayed on the display section to enter the hold state, and which performs the selected control process when no operation is performed to the image output apparatus for a predetermined time while the preview is being displayed.

2. The control apparatus as set forth in claim 1, wherein:
the job controlling section selects a control process suitable for a content of the job corresponding to the preview by referring to a storage section in which content information indicative of a content of a job and process information indicative of either the first control process or the second control process, which is suitable for the content of the job, are stored in advance in association with each other.

3. The control apparatus as set forth in claim 1, wherein:
the job controlling section selects the first control process when a total data amount, which is a data amount of all jobs in the hold state, is not less than a predetermined amount; and
the job controlling section selects the second control process when the total data amount is less than the predetermined amount.

4. The control apparatus as set forth in claim 1, wherein:
the job controlling section selects the first control process when the number of hold jobs, which is the number of jobs in the hold state, is not less than a predetermined number; and
the job controlling section selects the second control process when the number of hold jobs is less than the predetermined number.

5. The control apparatus as set forth in claim 1, further comprising:
a notification section which, in a case where the first control process is selected, notifies a user that the job corresponding to the preview displayed on the display section is to be executed, and which, in a case where the second control process is selected, notifies the user that the job corresponding to the preview displayed on the display section is to enter the hold state,
the notification section performing the notification when no operation is performed to the image output apparatus for a threshold time, which is shorter than the predetermined time, while the preview is being displayed.

6. The control apparatus as set forth in claim 1, further comprising:
a storage section in which to store identification information for identifying a user and a mail address of the user in association with each other;
a receiving section which receives identification information of a user who inputs a job; and
a mail processing section which obtains, from the storage section, a mail address associated with the identification information received by the receiving section, the mail processing section sending, to the obtained mail address, information indicating that the job has entered the hold state, when the second control process has been performed.

7. The control apparatus as set forth in claim 1, further comprising:
a storage section in which to store identification information for identifying a user and a mail address of the user in association with each other;
a receiving section which receives identification information of a user who inputs a job; and
a mail processing section which obtains, from the storage section, a mail address associated with the identification information received by the receiving section, the mail processing section sending, to the obtained mail address, information indicating that the job has been executed, when the first control process has been performed.

8. The control apparatus as set forth in claim 1, wherein:
the job is any one of a printing process of the image, a transmission process of the image, and a conversion process of converting the image into a predetermined file format.

9. A control apparatus which controls an image output apparatus that executes a job of outputting an image and a process of displaying a preview of the image on a display section before the job is executed, the control apparatus comprising:
a job controlling section which causes the image output apparatus to execute a job corresponding to a displayed preview when no operation is performed to the image output apparatus for a predetermined time while the preview is being displayed.

10. The control apparatus as set forth in claim 9, further comprising:
a notification section which notifies a user that the job corresponding to the preview displayed on the display section is to be executed,
the notification section performing the notification when no operation is performed to the image output apparatus for a threshold time, which is shorter than the predetermined time, while the preview is being displayed.

11. The control apparatus as set forth in claim 9, further comprising:
a storage section in which to store identification information for identifying a user and a mail address of the user in association with each other;
a receiving section which receives identification information of a user who inputs a job; and
a mail processing section which obtains, from the storage section, a mail address associated with the identification information received by the receiving section, the mail processing section sending, to the obtained mail address, information indicating that the job has been executed, when the job has been executed.

12. The control apparatus as set forth in claim 9, wherein:
the job is any one of a printing process of the image, a transmission process of the image, and a conversion process of converting the image into a predetermined file format.

13. A control apparatus (i) which controls an image output apparatus that executes a job of outputting an image and a process of displaying a preview of the image on a display section before the job is executed, (ii) which is capable of causing the job to enter a hold state and releasing the job from the hold state, and (iii) which causes the image output apparatus to execute a job that is not in the hold state, in priority to a job in the hold state, the control apparatus comprising:
a job controlling section which causes a job corresponding to a preview displayed on the display section to enter the hold state when no operation is performed to the image output apparatus for a predetermined time while the preview is being displayed.

14. The control apparatus as set forth in claim 13 further comprising:
a notification section which notifies a user that the job corresponding to the preview displayed on the display section is to enter the hold state,
the notification section performing the notification when no operation is performed to the image output apparatus for a threshold time, which is shorter than the predetermined time, while the preview is being displayed.

15. The control apparatus as set forth in claim 13, further comprising:
a storage section in which to store identification information for identifying a user and a mail address of the user in association with each other;
a receiving section which receives identification information of a user who inputs a job; and
a mail processing section which obtains, from the storage section, a mail address associated with the identification information received by the receiving section, the mail processing section sending, to the obtained mail address, information indicating that the job has entered the hold state, when the job has entered the hold state.

16. The control apparatus as set forth in claim 13, wherein:
the job is any one of a printing process of the image, a transmission process of the image, and a conversion process of converting the image into a predetermined file format.
